(19) United States
(12) Patent Application Publication
(10) Pub. No.: US 2021/0375536 A1
(43) Pub. Date: Dec. 2, 2021

(54) MIXED MATERIAL MAGNETIC CORE FOR SHIELDING OF EDDY CURRENT INDUCED EXCESS LOSSES

(71) Applicants: North Carolina State University, Raleigh, NC (US); UNITED STATES DEPARTMENT OF ENERGY, Washington, DC (US)

(72) Inventors: Richard B. Beddingfield, Raleigh, NC (US); Subhashish Bhattacharya, Raleigh, NC (US); Paul Richard Ohodnicki, Allison Park, PA (US); Kevin Michael Byerly, Pittsburgh, PA (US)

(73) Assignee: UNITED STATES DEPARTMENT OF ENERGY, WASHINGTON, DC (US)

(21) Appl. No.: 16/762,072

(22) PCT Filed: Nov. 6, 2018
(86) PCT No.: PCT/US2018/059503

§ 371 Date: May 6, 2020

Related U.S. Application Data
(60) Provisional application No. 62/582,107, filed on Nov. 6, 2017.

(51) Int. Cl. H01F 27/34; H01F 27/25; H01F 27/36; H01F 27/28

(52) U.S. Cl. CPC H01F 27/346; H01F 27/28; H01F 27/363; H01F 27/25

(57) ABSTRACT

Various examples are provided related to mixed material magnetic cores, which can be utilized for shielding of eddy current induced excess losses. In one example, a magnetic core includes a ribbon core and leakage prevention or redirection shielding surrounding at least a portion of the ribbon core. The leakage prevention or redirection shielding can be positioned adjacent to the ribbon core and between the ribbon core and a magnetomotive force (MMF) source such as, e.g., a coil. The leakage prevention or redirection shielding extend beyond the ends of the MMF source and, in some implementations, can extend over the ends of the MMF source. In another example, a magnetic device can include a ribbon core, a MMF and leakage prevention or redirection shielding positioned between the MMF source and the ribbon core.

### CROSS REFERENCE TO RELATED APPLICATIONS

This application claims priority to, and the benefit of, co-pending U.S. provisional application entitled “Mixed Material Magnetic Core for Shielding of Eddy Current Induced Excess Losses” having Ser. No. 62/582,107, filed Nov. 6, 2017, which is hereby incorporated by reference in its entirety.

### STATEMENT REGARDING FEDERALLY SPONSORED RESEARCH OR DEVELOPMENT

This invention was made with government support under grant number DE-EE0007508 awarded by the Department of Energy. The Government has certain rights in the invention.

### BACKGROUND

Magnetic ribbon cores can be used in wide bandgap based power electronic converters. These cores meet the high power density and medium frequency excitation requirements that are desired in modern systems.

### SUMMARY

Aspects of the present disclosure are related to mixed material magnetic cores. In one aspect, among others, a magnetic core comprises a ribbon core; and leakage prevention or redirection shielding surrounding at least a portion of the ribbon core. The leakage prevention or redirection shielding can be positioned adjacent to the ribbon core and between the ribbon core and a magnetomotive force (MMF) source. In one or more aspects, the MMF source can be a coil wound around a portion of the ribbon core. The leakage prevention or redirection shielding can extend beyond ends of the coil. The leakage prevention or redirection shielding can be a bar shield or a wing shield. The wing shield can comprise wings that extend over ends of the MMF source. The MMF source can be offset from the leakage prevention or redirection shielding by a distance. The leakage prevention or redirection shielding can extend over ends of the MMF source with an offset from the ends of the MMF source by the distance.

In various aspects, the leakage prevention shielding can comprise leakage prevention shielding material selected from Cu, Al, or mu metal. The leakage prevention or redirection shielding can comprise leakage redirection shielding material selected from mu metal, lower permeability ribbon, powder core, or ferrite. The leakage prevention or redirection shielding can comprise permeability engineered tape wound core material. The leakage prevention or redirection shielding can be positioned along a portion of an inner surface of the ribbon core and a portion of an outer surface of the ribbon core opposite the portion of the inner surface. The leakage prevention or redirection shielding positioned along the outer surface of the ribbon core can extend beyond ends of the leakage prevention or redirection shielding positioned along the inner surface of the ribbon core, or can be a mirror image of the leakage prevention or redirection shielding positioned along the inner surface of the ribbon core.

In another aspect, a magnetic device comprises a ribbon core; leakage prevention or redirection shielding; and a magnetomotive force (MMF) source positioned around at least a portion of the ribbon core, where at least a portion of the leakage prevention or redirection shielding is between the ribbon core and the MMF source. In one or more aspects, the magnetic device can be a transformer. The MMF source can be a coil wound around a portion of the ribbon core. The coil can be wound around a second coil that is wound around the portion of the ribbon core, and the leakage prevention or redirection shielding can be between the two coils. The magnetic device can comprise multiple coils that are wound around each other. The leakage prevention or redirection shielding can be a bar shield extending between ends of the MMF source, or a wing shield extending over ends of the MMF source. The MMF source can be offset from the leakage prevention or redirection shielding by a distance.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A-1D are graphical representations of examples of ribbon core assembly geometries, in accordance with various embodiments of the present disclosure.

FIGS. 2A-2E are graphical representations of examples of leakage prevention shielding on ribbon (or tape wound) cores, in accordance with various embodiments of the present disclosure.

FIG. 3 is a schematic diagram illustrating an example of a magnetic path model, in accordance with various embodiments of the present disclosure.

FIGS. 4A-4C illustrate analysis of an example of a bar shield, in accordance with various embodiments of the present disclosure.

FIGS. 5A-5C illustrate analysis of examples of wing shields, in accordance with various embodiments of the present disclosure.

FIGS. 6A and 6B illustrate an example of a tangential component of magnetic flux and a normal component of magnetic flux at a material interface, respectively, in accordance with various embodiments of the present disclosure.

FIGS. 7A and 7B graphically illustrate the angle of flux between two materials and the flux components at the material interface, respectively, in accordance with various embodiments of the present disclosure.

FIG. 8 illustrates an example of induced eddy current impact on tangential and normal flux at the interface, in accordance with various embodiments of the present disclosure.

FIG. 9 illustrates an example of fringing permeance paths for a half of a UI core geometry, in accordance with various embodiments of the present disclosure.

FIGS. 10A, 10B and 100 illustrate examples of leakage finite-element analysis (FEA) for an adjacent winding configuration, an abutting winding configuration and a concentric winding configuration, respectively, in accordance with various embodiments of the present disclosure.

FIGS. 11A and 11B are tables illustrating permeance and flux encounters for core connections of constitutive geometries, in accordance with various embodiments of the present disclosure.

FIGS. 12A and 12B illustrate a simplified geometry and flux path segmentation of an adjacent winding transformer, respectively, in accordance with various embodiments of the present disclosure.

FIG. 13 is a schematic diagram illustrating an example of a magnetic equivalent circuit considering componentized leakage paths, in accordance with various embodiments of the present disclosure.

FIGS. 14A and 14B illustrate magnitude and path proportion of winding configuration dependent total surface leakage flux, respectively, in accordance with various embodiments of the present disclosure.

FIG. 15 illustrates an example of eddy current in magnetic ribbon paths, in accordance with various embodiments of the present disclosure.

FIG. 16 illustrates an example of a modified transformer electrical equivalent circuit, in accordance with various embodiments of the present disclosure.

FIGS. 17A and 17B illustrate examples of graded permeability based and high conductivity based normal leakage flux reduction, respectively, in accordance with various embodiments of the present disclosure.

FIGS. 18A-20 illustrate examples of magnetic equivalent circuits including leakage shielding and FEA models, in accordance with various embodiments of the present disclosure.

FIGS. 21A-21C are images of a medium frequency transformer comparing examples of magnetizing and leakage test thermal profiles, in accordance with various embodiments of the present disclosure.

FIGS. 22A and 22B illustrate examples of optical line scan measurements of transformer thermal profiles for magnetizing and leakage tests, in accordance with various embodiments of the present disclosure.

FIG. 23 illustrates an example of the measured leakage flux field around the transformer upper right octant, in accordance with various embodiments of the present disclosure.

FIGS. 24A-24F are images of a 10 kW unshielded DAB transformer comparing examples of magnetizing and leakage test thermal profiles, in accordance with various embodiments of the present disclosure.

FIG. 25 illustrates a loss map for magnetizing and leakage losses of the core in FIG. 24A, in accordance with various embodiments of the present disclosure.

FIGS. 26A-26D are images of a 10 kW DAB transformer with a bar shield comparing examples of magnetizing and leakage test thermal profiles, in accordance with various embodiments of the present disclosure.

FIGS. 27A-27C are images of a 10 kW DAB transformer with a wing shield comparing examples of magnetizing and leakage test thermal profiles, in accordance with various embodiments of the present disclosure.

FIG. 28 illustrates a loss map comparing losses of the unshielded and shielded cores of FIGS. 24A, 26A and 27A, in accordance with various embodiments of the present disclosure.

FIGS. 29A-29C illustrate variations between the unshielded and shielded cores of FIGS. 24A, 26A and 27A, in accordance with various embodiments of the present disclosure.

FIGS. 30A and 30B illustrate a two-port transformer with integrated shielding, in accordance with various embodiments of the present disclosure.

FIGS. 31A-31D illustrate the effects of peak flux density at no-load and full load, in accordance with various embodiments of the present disclosure.

FIG. 32 is a schematic diagram illustrating the test setup for the two-port transformer with integrated shielding of FIGS. 30A and 30B, in accordance with various embodiments of the present disclosure.

FIGS. 33A-33K illustrate test results of the two-port transformer with integrated shielding of FIGS. 30A and 30B, in accordance with various embodiments of the present disclosure.

### DETAILED DESCRIPTION

Disclosed herein are various examples related to mixed material magnetic cores, which can be utilized for shielding of eddy current induced excess losses. Reference will now be made in detail to the description of the embodiments as illustrated in the drawings, wherein like reference numbers indicate like parts throughout the several views.

Generally, magnetic ribbon cores have a relatively high electrical conductivity that can lead to increased eddy currents over similar ferrite based designs. To mitigate this, the ribbon thickness can be reduced to limit the conductive area. This can work well for magnetizing flux induced eddy currents. However, in components with intentional leakage flux such as a dual active bridge transformer, the geometric design can force the flux path to enter the ribbon's broad surface causing excessive eddy currents. Using anisotropic (magnetic ribbon) and isotropic (ferrite) materials, an additional leakage flux path can be introduced into the transformer. This path can ensure that there is adequate leakage inductance while enabling the leakage flux to complete the flux loop without inducing excess eddy currents.

The leakage flux can hit the ferrite material which has a high resistivity at any angle that is physically appropriate. However, negligible excess eddy currents are generated due to the high resistivity of the ferrite material. Since the ferrite is not used as the main magnetizing branch, high power density and low losses and parasitic capacitance are maintained. This technology can enable traditional transformer design and construction techniques to be used for design in medium frequency applications, which can be a choke point in the adoption of wide bandgap semiconductors. Without this design and construction technology, magnetic devices can experience a significant increase in losses. This technology can be used to solve issues in magnetic devices (inductors and transformers) related to medium frequency applications, which is considered in the context of magnetic cores using magnetic ribbons of amorphous, steels, and amorphous and nanocrystalline nanocomposite alloys as the primary core material. This technology is also relevant for conventional steel cores or other soft magnet materials with relatively high electrical conductivity. This shielding can also provide protection to ambient systems where stray flux could cause issues.

Various materials were studied for shielding effects to mitigate against undesired leakage flux normal to the surface of tape wound cores in high frequency applications. Normal leakage fluxes result in eddy currents which are induced within the plane of the tape-wound ribbon, thereby creating excessively large losses due to the large lateral dimensions within the ribbon plane. Two approaches that can be pursued are prevention or redirection of the leakage flux.

Prevention of leakage flux is when the leakage flux encounters a material which prevents the flux from emanating from or to, crossing or intersecting the surface of cores and is thus repelled resulting in a reduced overall leakage flux. For example, prevention can be accomplished by placing an electrical conductor in close proximity to the core surface such that normal flux results in an induced eddy current which then repels it from emanating or deflects the flux from the magnetic core surface.

Flux redirection techniques attempt to maintain the total leakage flux to accomplish a desired leakage inductance for a particular converter design and direct it to its return path without encountering the principal core material and/or without a significant contribution of flux normal to the principle core material surface as it exits the core. Flux redirection takes advantage of shielding materials with finite permeability and low or moderate electrical conductivity in order to guide the leakage flux away from the principle core normal without the need for large leakage flux induced eddy currents.

Examples of potential leakage flux shielding materials include, but are not limited to, copper, mu metals, lower permeability amorphous and nanocrystaline ribbon or powder, metallic powders embedded in an epoxy or other binder, and ferrites. Copper, which can be used for leakage flux prevention, can prevent most high frequency AC flux from entering the ribbon due to induced eddy currents in the conductor. Very high currents induced from AC leakage flux within the copper can shield material. Mu metal, which can be used for leakage flux prevention and/or redirection, can redirect a significant amount of AC and DC leakage flux when placed adjacent to the principle core material due to the high permeability. Significant eddy currents can be induced from the AC leakage flux. Lower permeability amorphous and nanocrystaline ribbon or powder, or other metallic powder based materials, which can be used for leakage flux prevention and/or redirection, can redirect a significant amount of flux entering the ribbon due to the finite, but lower permeability. Moderate eddy currents can be induced from the finite electrical conductivity of the ribbons. Ferrite, which can be used for leakage flux prevention and/or redirection, can redirect most flux entering the ferrite shield depending on the selected permeability. Relatively low eddy currents can be induced (typically negligible) such that leakage flux prevention does not occur. It should be emphasized, that depending upon the specific geometrical construction a particular material may act primarily as an element to accomplish leakage flux prevention, leakage flux redirection, or even some combination of both.

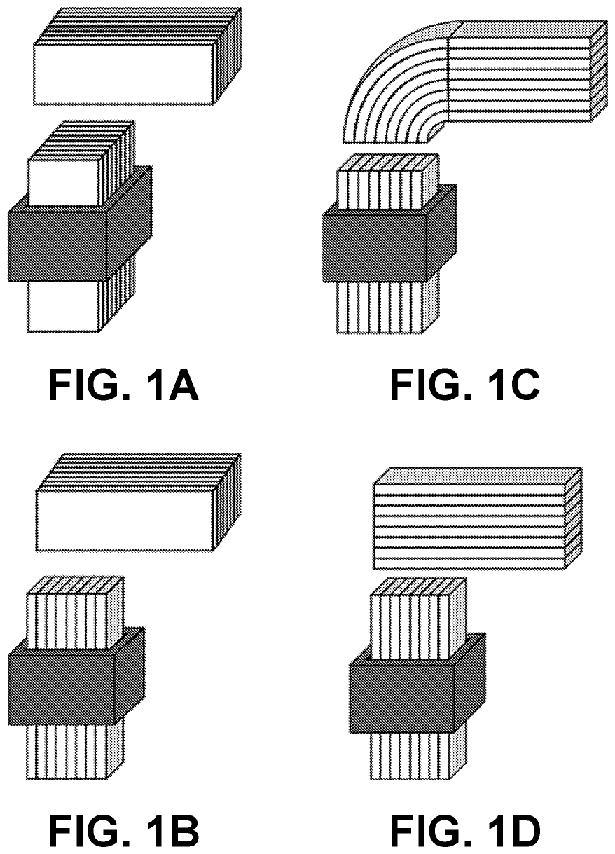

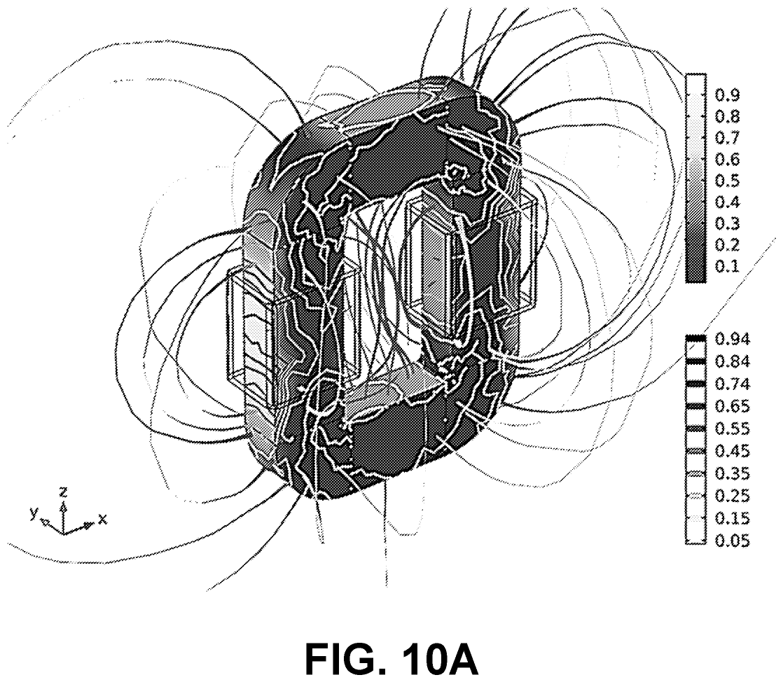

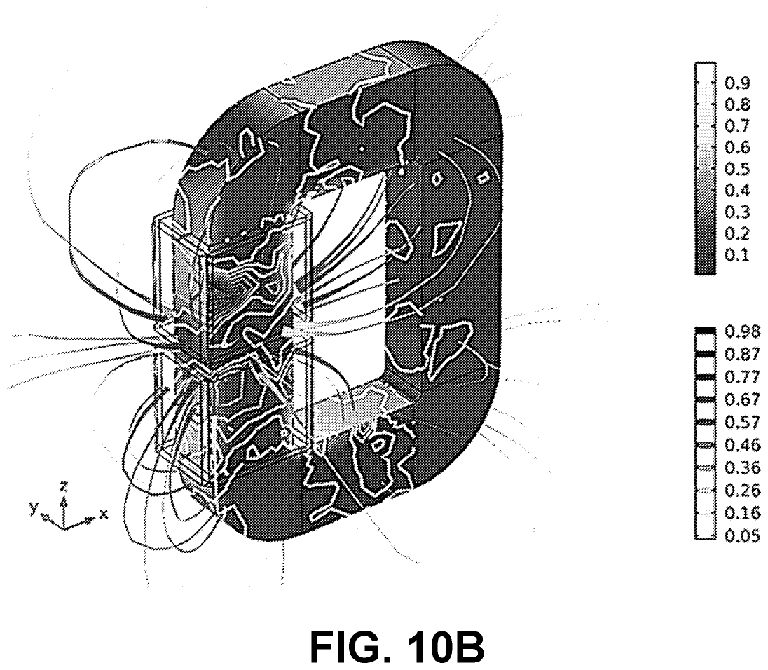

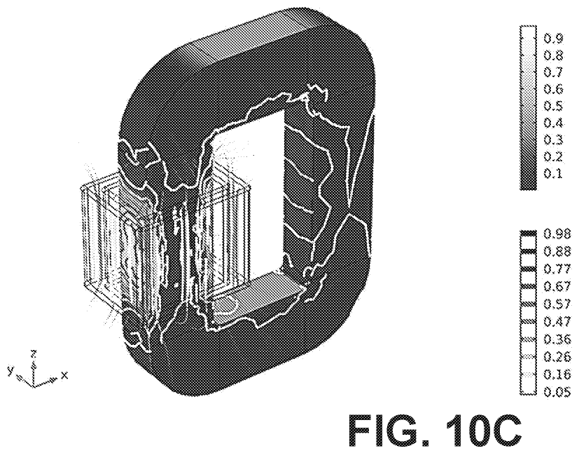

Different core geometries can utilize different shielding approaches. Referring to FIGS. 1A-1D, shown are four examples of different assembly geometries using common ribbon core building blocks. FIG. 1A illustrates an edge on edge configuration, FIG. 1B illustrates a rotated edge on edge configuration, FIG. 10 illustrates a wound ribbon configuration, and FIG. 1D illustrates a face on edge configuration. Since the ribbon edges are not adjacent, the face on edge configuration generally should be avoided. FIGS. 1A-1D show both gapless connections and gapped connections where the visual gap is only one possible gap location. However, the illustrated gap is relationally consistent. Using these geometries, the number of surfaces (broad ribbon surfaces) that can need shielding are predicted in the following table.

| Core | Magnetizing | Window | Outer | Page | Inner | Outer | Page |
|---|---|---|---|---|---|---|---|
| Connection | Flux | Leakage | Leakage | Leakage | Fringing | Fringing | Fringing |
| Rotated | 0 | 2 | 2 | 0 | 1 | 2 | 1 |
| Wound | 0 | 4 | 2 | 0 | 2 | 2 | 0 |
| Edge on | 0 | 0 | 0 | 2 | 0 | 0 | 2 |
| Edge | | | | | | | |
| Face on | 1 | 4 | 2 | 0 | 2 | 1 | 0 |
| Edge | | | | | | | |

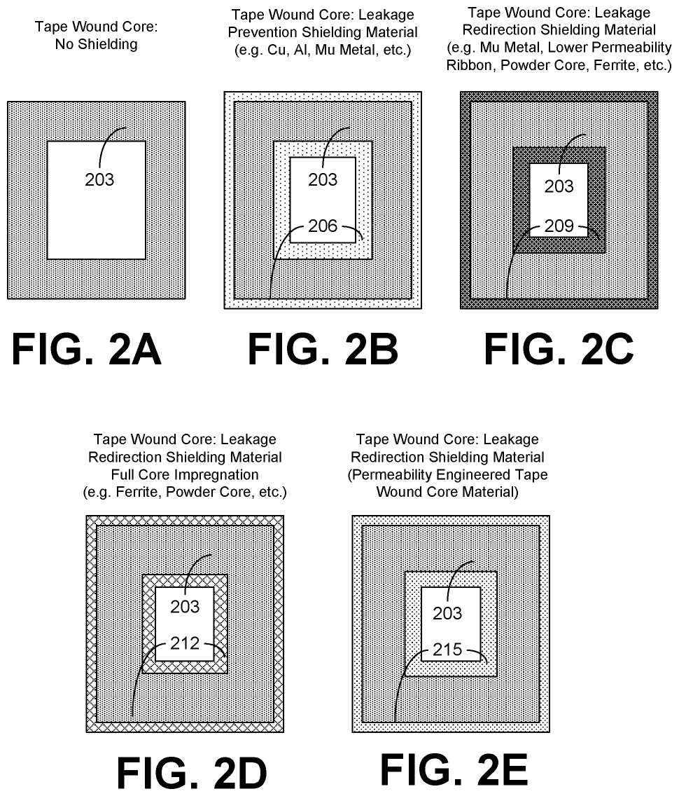

Examples of various leakage shielding approaches that can be pursued using leakage flux shielding materials are graphically illustrated in FIGS. 2A-2E. FIG. 2A shows a core 203 with no shielding, which may represent for example a tape wound core. Various shielding approaches can be used for the tape wound core 203 including leakage prevention materials, leakage shielding materials, full core impregnation with leakage shielding materials, and/or permeability engineered tape wound core materials. FIG. 2B shows an example of the tape wound core 203 with leakage prevention shielding material 206 (e.g., Cu, Al, mu metal, other appropriate conductive, non-magnetic materials, etc.), FIG. 2C shows an example of the tape wound core 203 with leakage redirection shielding material 209 (e.g., mu metal, lower permeability ribbon, powder core, ferrite, other appropriate soft-magnetic materials, etc.), FIG. 2D shows an example of the tape wound core 203 with leakage redirection shielding material with full core impregnation 212 (e.g., ferrite, powder core, etc.), and FIG. 2E shows an example of the tape wound core 203 with leakage redirection shielding material 215 of permeability engineered tape wound core material.

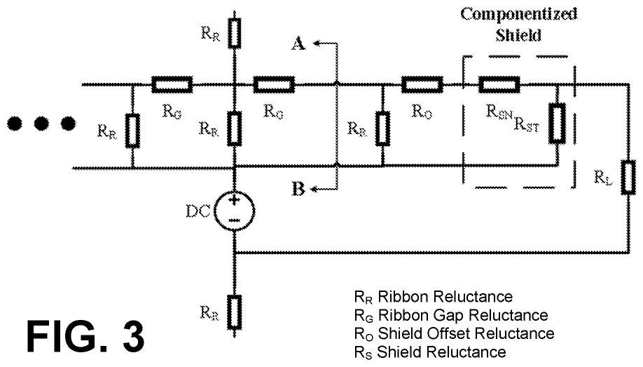

For designs where a finite leakage inductance is needed, leakage flux redirection based methods have been determined to be most suitable in order to avoid an undesired reduction in overall leakage flux and leakage inductance for the design. As such, a model for the magnetic paths of the principal core ribbon and the shield was developed for a case in which a shield is employed that primarily serves to redirect the leakage flux. FIG. 3 illustrates the magnetic path model of the principle core ribbon and shield. In the particular geometry of FIG. 3, tangential paths return flux to the source and normal paths divert flux to other paths. The normal and tangential paths are separated and componentized into normal and tangential paths of the model. In the case where the componentized path is a very high reluctance or very low reluctance, it can be simplified as an open path or a shorted path, respectively. As an example, a normal path between the ribbons can be an open and the tangential path along the ribbon can be treated as a short. In the model of FIG. 3, the subscripts ‘T’ and ‘N’ are used to represent tangential and normal paths, respectively.

Any of the types of shielding materials described above can be leveraged in the context of a power magnetics component design. Because the primary interest is in designs that retain the leakage flux/inductance but avoid the associated leakage induced eddy current losses that can result, ferrite has been used as a flux redirection type shield. An emphasis has also been placed on minimizing the disruption to standard manufacturing processes of tape wound cores through selective addition of shielding materials at locations which provide an increased (e.g., the largest or maximum) amount of flux redirection with a reduced (e.g., for the minimum) amount of additional shielding material and overall core volume. With that, technique follows the following guiding principles:
1. Increase R_{SN} and Rₒ to make it difficult for leakage flux to reach the principal core ribbon; and
2. Decrease R_{ST} to make it easy for leakage flux to return to the source.

For example, the technical approach can follow two basic geometries, bar and wing shields, which are discussed below. However, additional approaches can also be utilized as well, including approaches that include locally tuning the permeability of tape wound cores without the need for additional ferrite materials in order to guide the leakage flux away from the normal of tape wound core surfaces. Alternatively, a method for coating the entire outer surface of a core with a high resistivity ferrite or a powder core material of sufficient thicknesses can also been used to allow for reduced or minimized normal leakage flux losses of tape wound cores comprising amorphous and nanocomposite alloys of arbitrary geometries.

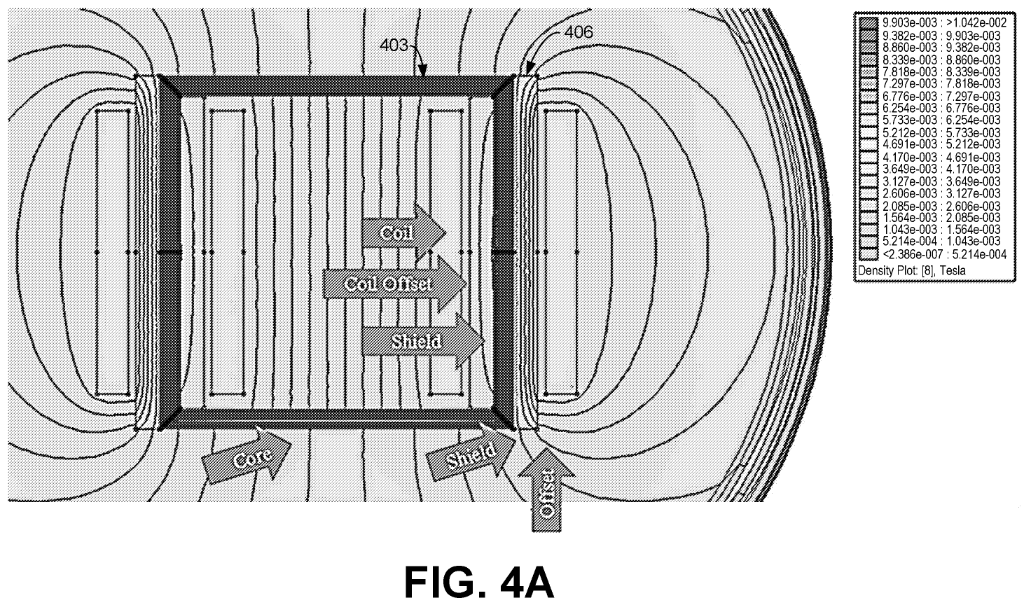

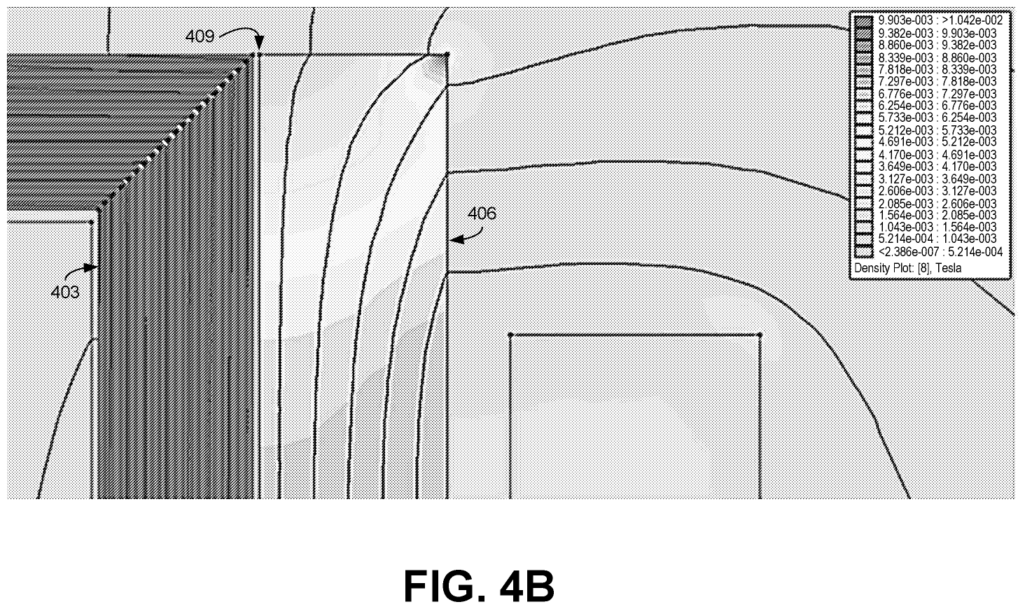

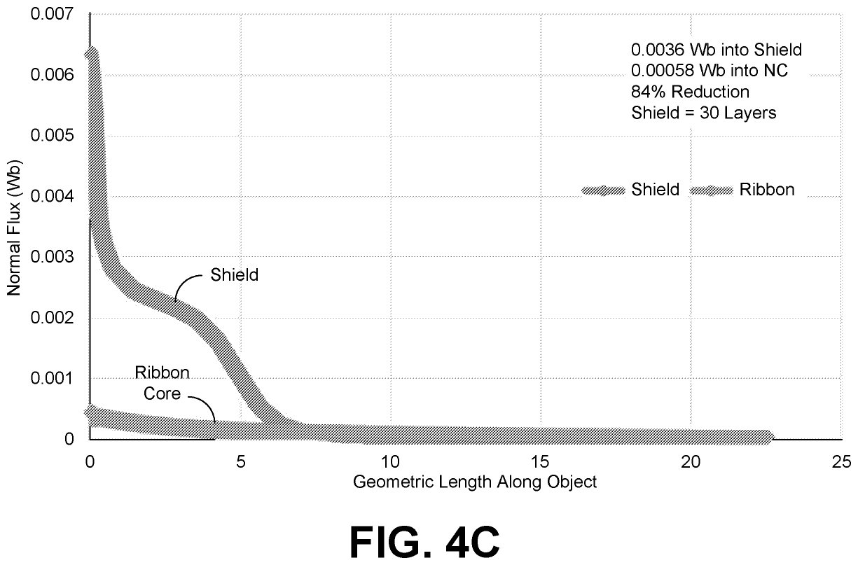

BAR SHIELD. The design principle of the bar shield is first to ‘catch’ and redirect the leakage flux of a magnetic component (e.g., a coil) before it hits the principal core ribbon 403. The leakage flux then completes its loop through the high resistivity material of the shield 406 without inducing significant eddy currents. The bar shield 406 can be designed to be closest to the principal core material areas where the dominant leakage flux would normally enter. FIG. 4A shows a finite-element analysis (FEA) of an example of the bar shield approach for a ribbon core 403, and FIG. 4B provides a zoomed-in view of a portion of FIG. 4A illustrating the flux diversion from the core 403 into the ribbon path. Note the low flux region 409 between the principal ribbon core 403 and the shield 406. This shows that the redirected flux in the shield 406 does not enter the ribbon core 403 but rather returns to the magnetomotive force (MMF) source. FIG. 4C graphically illustrates a comparison of the normal flux entering the shield 406 and the ribbon core 403. The majority of normal flux enters the shield 406 rather than the tape wound core ribbon 403 demonstrating the efficacy of the approach. As shown in FIGS. 4A and 4B, the MMF source (e.g., a coil) is offset from the shield 406 by a distance. The offset can provide some degree of tunability to the amount of flux shielded and the resulting volume and copper coil length. The offset distance can range between no gap with the MMF source, the shield touching the MMF source, to a larger gap of arbitrary length. Component design and optimization can be used dictate the distance and/or length of the offset. The offset can be filled with an insulating material.

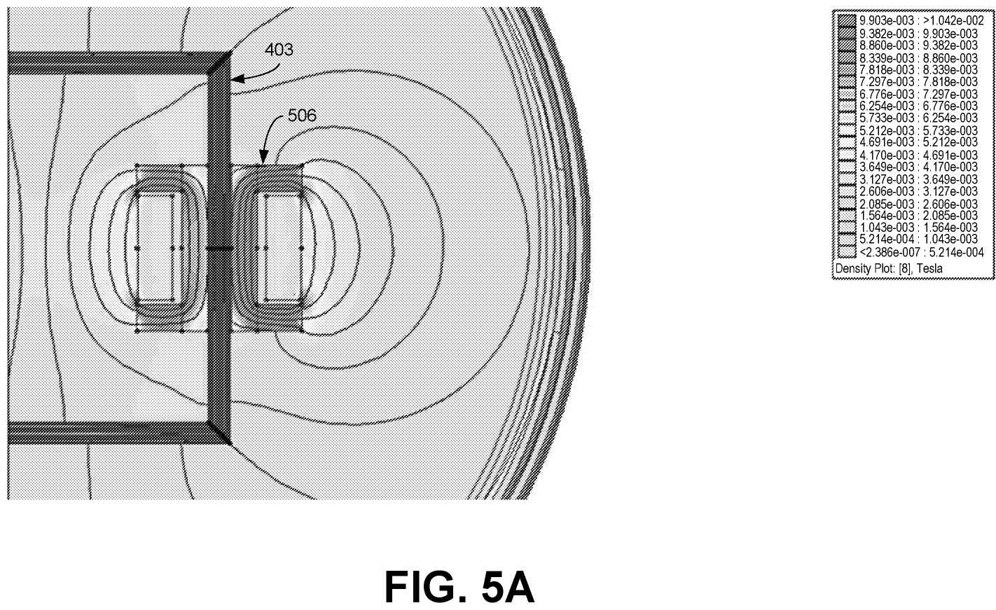

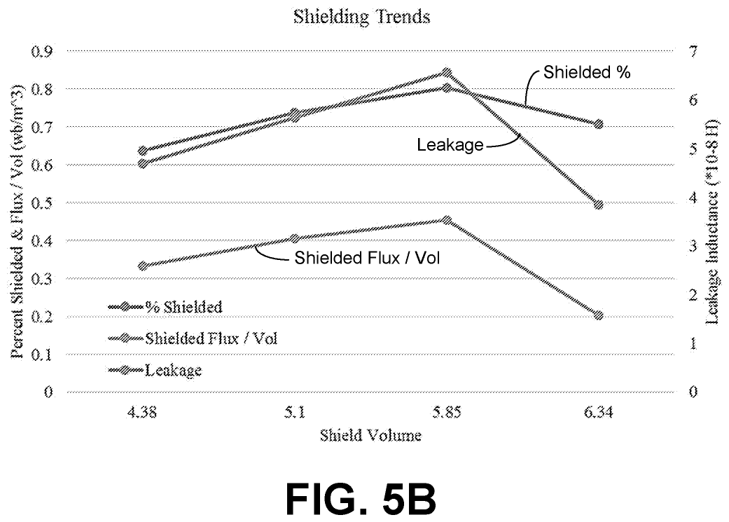

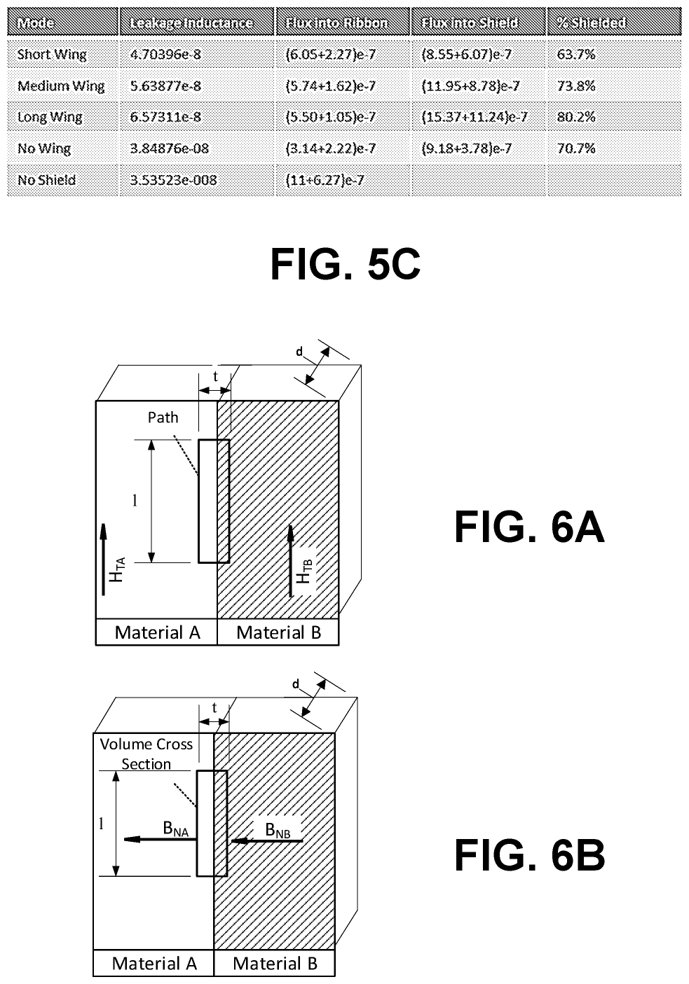

WING SHIELD. The wing shield approach follows the general design approach of the bar shield 406. However, the wing shield 506 includes ‘wings’ that stretch out to enclose the winding (MMF source). FIG. 5A shows a finite-element analysis (FEA) of an example of the wing shield approach for a ribbon core 403. These wings act to provide more direct leakage path around the MMF. Less shield material is needed with the wing shield 506 configuration because the leakage flux is both absorbed and diverted. The wings that extend beyond the exciting coils have a significant impact on the leakage path and can be even more effective. However, the total leakage flux and hence the total leakage inductance can be impacted more strongly by this approach due to the introduction of an additional low permeance path resulting in higher effective leakage flux than the bar shield design.

For the wing shielding approach, the horizontal “wing” was increased from the FEA of FIG. 5A to analyze the effects. FIG. 5B shows a chart that compares the increased wing sizes (increases in total volume) to various performance metrics. In contrast to the wing shield 506, the bar shield 406 comprises significantly more volume to shield less but from a manufacturability perspective is likely to be more straight forward to incorporate into a given design without major modifications to the overall core design which is typically implemented. The table of FIG. 5C provides supporting values for the chart of FIG. 5B by comparing three wing shield, a bar shield (no wing) and no shield configurations.

Leakage Flux

To more fully understand the significance of the leakage prevention or redirection shielding, leakage inductance and the associated losses are examined. In traditional magnetic designs of low frequency or high frequency magnetics, stray flux in the form of leakage, fringing, or other non-magnetizing flux has not been considered a lossy component. That is, low frequency devices using laminated magnetic cores do not have a high enough frequency for stray flux to cause losses. High frequency devices using ferrite material can also neglect eddy currents associated with stray fluxes as ferrites have a high resistivity isotopically. As low frequency transformers have grown both physically and in power rating, concern for leakage based losses has increased. A similar issue exists with very high power magnetics that also have significant stray fields. These fields can introduce losses with the case. At medium frequencies and high powers, were laminated materials are used, the stray flux paths can contribute to losses. In order to improve designs of these materials, flux models (along with models of other parasitic elements) are examined for stray loss calculation.

Flux Path at the Interface of Materials. Leakage flux and leakage inductance are difficult to calculate due the three dimensional space that the magnetic field exists in. Particularly, magnetic flux will flow through a volume that depends not only on the volumes magnetic permeability but also any interface with other volumes. FIGS. 6A and 6B illustrate an example of tangential and normal components, respectively, of magnetic flux at a material interface. The deflection of flux between two materials, A and B of relative permeability of μ_{A} and μ_{B} respectively, can be determined. By first investigating the tangential component of field intensity, a loop is enclosed around the interface of two materials, of length l and thickness t, as shown in FIG. 6A. Note that the thickness approaches zero and no externally applied current is enclosed in the loop. Similarly, following Amperes law:

[symbol]

H·dl=l_{enc} (1.1)

H_{TA}=H_{TB} (1.2)

shows the relationship between tangential fields. From this equality:

$$\frac{{ϕ}_{TA}}{A {μ}_{rA} {μ}_{0}} = \frac{{ϕ}_{TB}}{A {μ}_{rB} {μ}_{0}} \qquad ( 1.3 )$$

shows how the tangential component of the magnetic flux behaves at the interface of the two materials. This is appropriate for an arbitrary area, A, that goes into the page arbitrarily and is along the thickness t. Then,

$$\frac{{ϕ}_{TA}}{{ϕ}_{TB}} = \frac{{μ}_{rA}}{{μ}_{rB}} \qquad ( 1.4 )$$

shows the ratio of tangential components between the two interfaces is simply the ratio of the permeability of the two materials. Next, the normal component of magnetic flux can be determined by examining FIG. 6B, there is an enclosed volume with thickness, t, that approaches zero. The volume has a depth of d into the material. Using Maxwell's equation:

[symbol]

B·ds=0 (1.5)

and understanding that no flux enters the sides of zero thickness,

B_{NA}=B_{NB} (1.6)

ϕ_{NA}=ϕ_{NB} (1.7)

shows the equivalency of the normal flux component between the two interfaces.

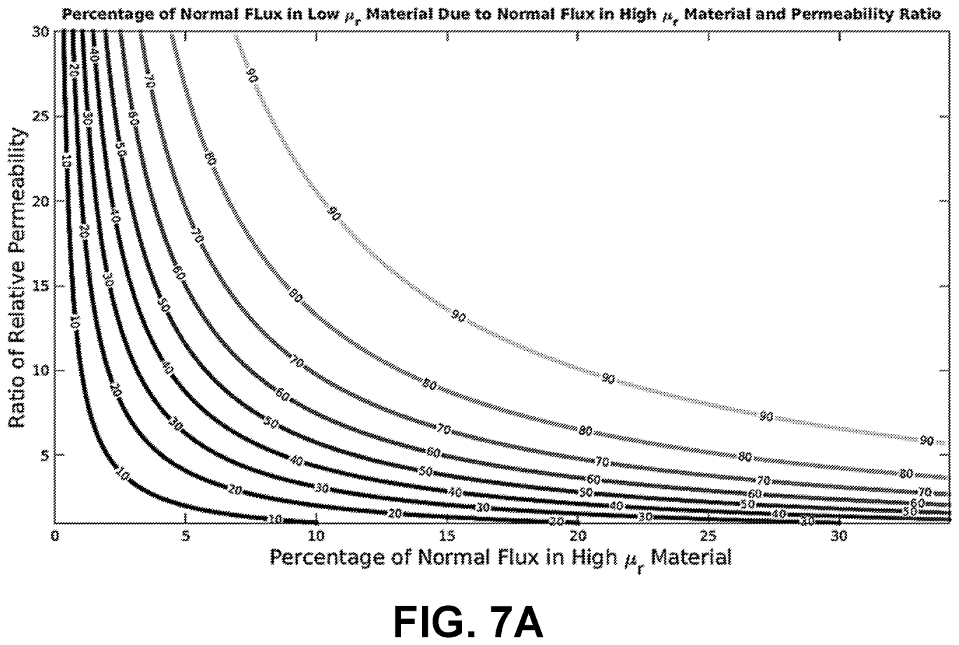

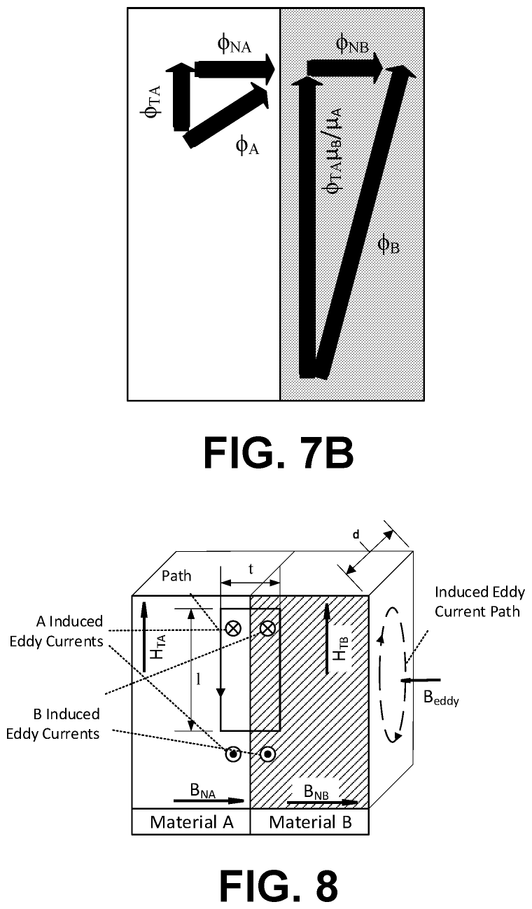

FIGS. 7A and 7B illustrate the angle of flux between two materials and the flux components at the material interface, μ_{B}>>μA, respectively. It is clear from FIG. 7A that for even low permeability ratios, only a small portion of the horizontal flux transitions from the high permeability material to the low permeability material. A conservative assumption is that all flux crossing air to the magnetic core is perpendicular to the core surface. As an example of a practical permeability ratio, μᵣ=5000, an angle of approach of only 1° translates to an 89.3° exit at the material interface or 99.9925% of the flux magnitude being normal to the surface.

Instead of the previous assumption where no enclosed current was considered, now the derivation considers the induced eddy currents due to the normal component of the flux density the tangential component changes. Following Amperes law, the tangential field intensity is related to the enclosed eddy current. FIG. 8 demonstrates the impact of the induced eddy currents on the flux path at the interface of two materials. For simplicity, assume that only meaningful eddy currents exist in material B. Both the tangential and normal flux components are affected by the induced current. Specifically, the tangential component is adjusted to:

$${ϕ}_{TA} = \frac{{μ}_{rA}}{{μ}_{rB}} {ϕ}_{TB} - {μ}_{0}^{2} {μ}_{rB} {DepthI}_{eddy} \qquad ( 1.8 )$$

and the normal component to:

$${B}_{NA} = {B}_{NB} - {B}_{eddy} = {B}_{NB} - \frac{{μ}_{0} {μ}_{rB} {I}_{eddy}}{{t}_{lam}} \qquad ( 1.9 )$$

The sign of the eddy current contribution in equation Error! Reference source not found.) depends on the model set up. It is clear however that given a small permeability ratio with low eddy currents, as in well-designed magnetic cores, the horizontal component that persists across the boundary is very small. If the material is highly conductive, and the eddy currents are significant, the horizontal component can provide significant distortion. However, a worst case design can neglect the induced eddy current impacts and assume that all of the flux traversing a low to high permeability region will approach the interface perfectly normal. In reality there will be some small angle contribution to the tangential and some small reduction in the normal to cause a real implementation that is less lossy than the estimate.

Permeance for Gap Fringing. Assuming that the flux enters a magnetic core from air normal, it is possible to derive the flux paths near core gaps. This permeance can be included in a magnetic circuit using Hopkinson's law to determine the leakage flux. The inclusion of these paths into the magnetic equivalent circuit enables direct prediction of fringing flux. The permeance path can be determined by investigating two methods of determining the energy in a coil. The permeance of the leakage path is P. First, coil energy as a function of coil current, I, and turns, N, is shown in:

E=½PN²I² (1.10)

Then, using

E=½μ₀∫H²dV (1.11)

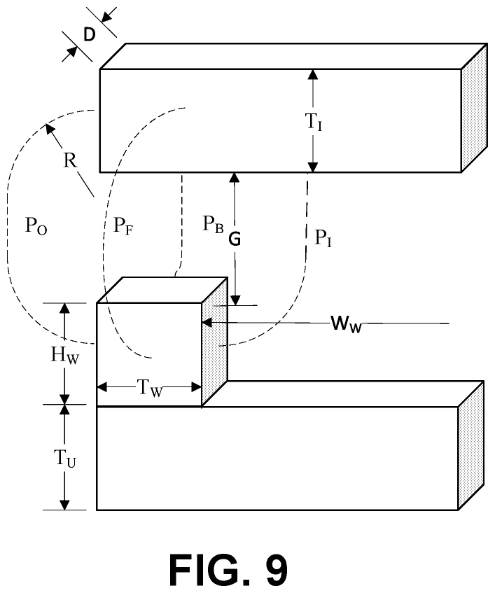

the stored energy is described as a volume integral function of the magnetic field, H. Using these equations and geometric parameters, as shown by the fringing permeance paths for a half of a UI core geometry in FIG. 9, the various fringing permeance paths can be determined and are shown in:

$${P}_{O} = D \frac{{μ}_{0}}{π} ln ( 1 + \frac{π}{G} w ) {\vert}_{w = min ( {T}_{I} , {H}_{w} + {T}_{U} )} \qquad ( 1.12 )$$

for the outside path,

$${P}_{I} = 2 D \frac{{μ}_{0}}{π} ln ( 1 + \frac{1}{2} \frac{π}{G} w ) {\vert}_{w = min ( {T}_{I} , \frac{{W}_{w}}{2} )} \qquad ( 1.13 )$$

for the inside path, and

$${P}_{F} = {P}_{B} = {T}_{w} \frac{{μ}_{0}}{π} ln ( 1 + \frac{π}{G} w ) {\vert}_{w = min ( {T}_{I} , {H}_{w} + {T}_{U} )} \qquad ( 1.14 )$$

for the two paths that enter the core front and back face.

Permeance for Leakage Flux. While there are many models for determining the leakage inductance, analyzing the total device flux by assembling constitutive geometries to interface with the core material and encompass an excitation coil is convenient for identifying and isolating different sub paths of the total leakage flux path. These geometries have a defined magnetic permeance that accounts for the magnetic permeance in the region. In order to determine which geometries are relevant, a Comsol FEA model of the test core was developed. Modelling anisotropic cores at medium frequencies and with eddy currents is a nontrivial task. Homogenization techniques can be used to account for anisotropic conductivity. It should also be noted that the vertical and horizontal core blocks have different tensors. The rounded corners also have a unique tensor and reference a cylindrical coordinate system. Comsol componentizes this coordinate system into Cartesian coordinates. However, the overall core anisotropy can be easily verified with analysis of magnetizing flux. Despite these advances, it is particularly challenging to develop FEA models that properly define all relevant physics for high power medium frequency magnetics. Therefore, these models were used to qualitatively identify behavior and performance trends. While they were not relied on for exact calculation, the models still provided significant insight.

Three of the most common transformer winding configurations were explored in FEA. These windings are adjacent as illustrated in FIG. 10A, abutting as illustrated in FIG. 10B, and concentric as illustrated in FIG. 100 (surface=|B|_{\hat{n}} normalized; contour=|Jᵢ|; streamers=leakage flux). While not examined here, other winding configurations such as, e.g., interleaved, shell or axial are possible. An advantage of these three designs is their ease of manufacturing and there relatively low parasitic capacitance. This makes them well suited for use in high power medium frequency applications. Due to the aforementioned difficulties in modelling, levels of various parameters were normalized to highlight relative magnitudes and hot spots.

The surface of the cores in the FEA results illustrate the magnitude of normal flux on the surface. An anisotropic permeability tensor was used to model a core permeability in the ribbon directions and ribbon, air stack in the normal direction. Contour lines on the core show the induced current density. Here, a diagonal conductivity tensor was used to model material conductivity on the ribbon and no conductivity between ribbons. Finally, the colored streamlines show the paths of leakage flux in air. The thickness of the lines corresponds to the relative magnitude of the leakage flux density. These streamlines were chosen to highlight where on the core physically the described leakage inductance enters the core with a first group of streamlines intersecting the outside broad ribbon surface while a second group of streamlines intersects the inside, window, broad ribbon surface. A third group of streamlines show that relatively low loss flux enters the face of the core. These paths are low loss because the available eddy current path is constrained by the thinness, several micrometers, of the magnetic ribbon.

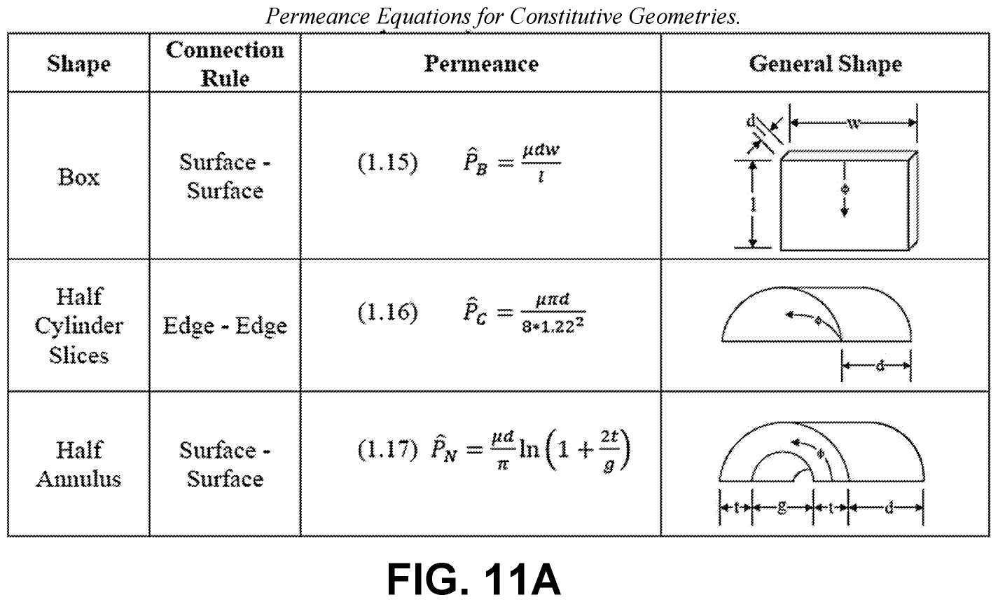

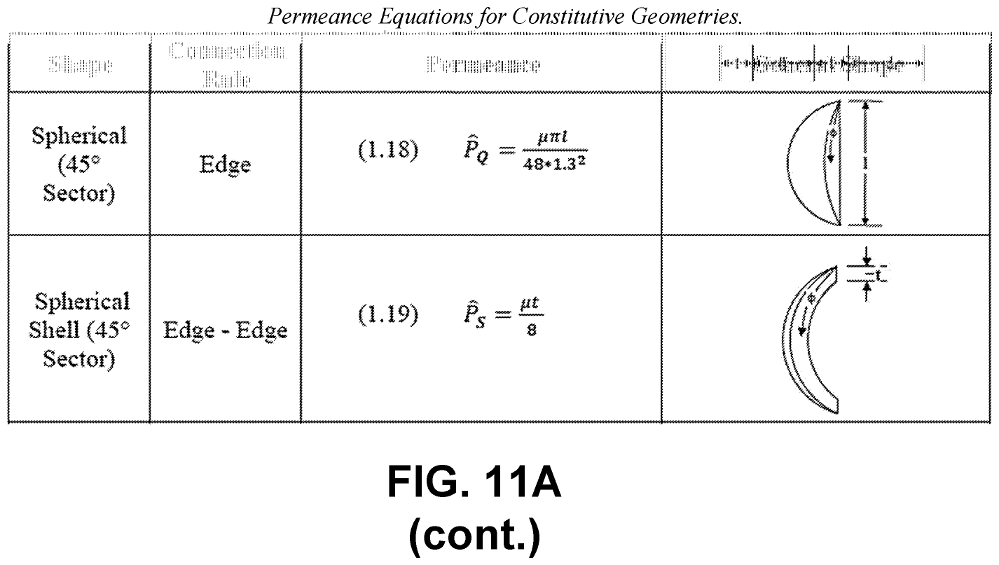

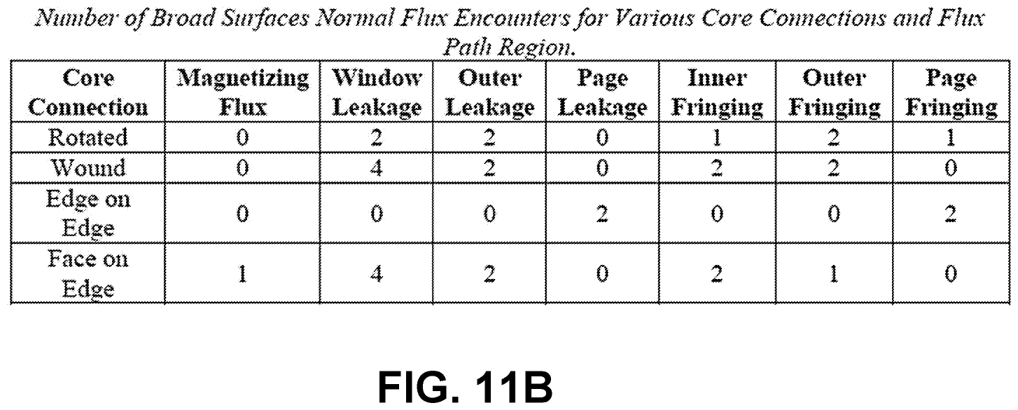

It can be seen from the FEA in FIGS. 10A-10C that there are five primary stray flux paths. These paths are boxes, half cylinder slices, half annuli, spherical slices and quarter rounds. Using FEA to identify the paths increases the certainty of the ‘Probable Flux Paths.’ The different flux paths can be grouped based on where they enter the core. This will be useful when accounting for losses as the different groups of paths enter into different parts of the core with different geometries and different loss coefficients. The general permeance, \hat{P}, equations for the five paths can be given by equations (1.15) to (1.19) listed in the table of FIG. 11. These equations are taken by determining a probable flux regions volume and mean path. Thus the geometric term of permeance, area by length is the same as volume by length squared. A practical example of this partitioning and leakage flux calculation is illustrated below using the adjacent winding transformer.

Using the permeance equations (1.15) to (1.19) listed in the table of FIG. 11A enables estimating the losses associated with the stray fields. First, the geometries can be used to decompose the paths of the stray flux around an exciting coil. Then, by observing where the constituent paths intersect with the core, the degree to which the path causes losses can be determined. This can be accomplished by determining if the path intersects the broad surface of the magnetic ribbon, a high loss path, or the stack of magnetic ribbon edges, negligible to low losses. Other paths that do not intersect with the core (e.g. between to concentric windings) do not cause any induced eddy current losses. An example of path counting is considered for the simple geometries shown in FIGS. 1A-1D.

FIGS. 1A-1D show a winding bundle in dark gray relative magnetic ribbon layers assembled in a core. FIGS. 1A-1D also show different orientations available if an air gap is desired. Note that while the geometry of FIG. 1D is physically possible, it should be avoided. The magnetizing flux crosses a broad surface of the core ribbon. This will induce significant eddy currents at the junction and result in excessive losses. Error! Reference source not found. table of FIG. 11B shows which magnetizing, leakage, and fringing, if a gap is used, paths that enter into the broad surface of the core ribbon. The ribbon edge surfaces are not counted as the induced eddy current loss will be negligible because the available eddy current path is very small.

Modelling Leakage Flux and Losses

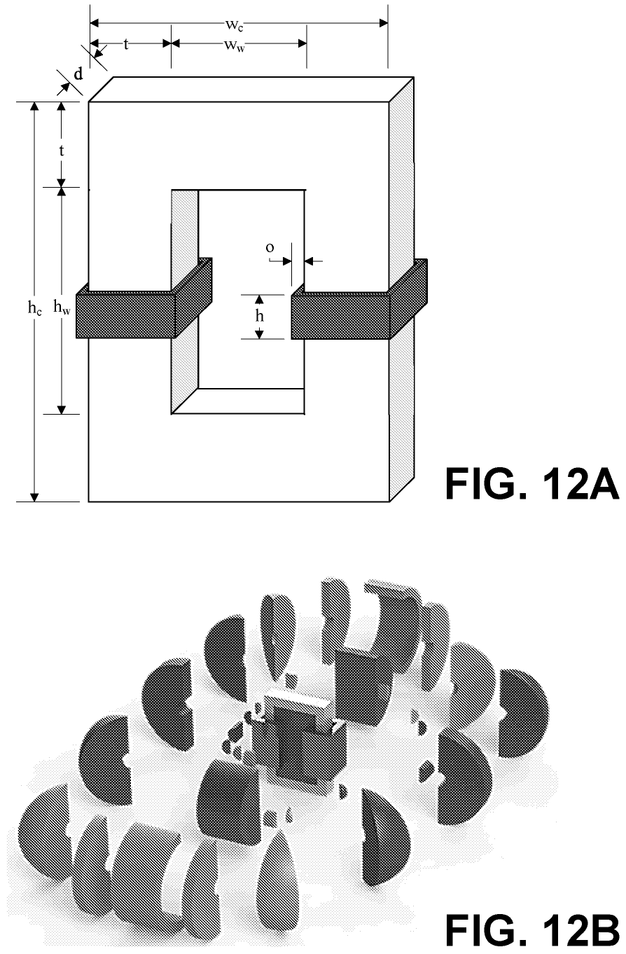

The first step in the design process is to determine the different leakage flux paths. A simplified geometry of a practical core assembled of wound ribbon as shown in FIG. 1B, without any gaps is illustrated in Error! Reference source not found. 12A, with symmetric dimensions unlabeled. This geometry simplifies some of the discrepancies in core curvature and dimensional mismatches due to construction. FIG. 12B illustrates the breakdown of the permeance paths using the geometries of FIG. 11A. These paths are assembled to complete leakage flux torus around the excitation coils. Darker paths are high loss and intersect the outside and the inside of the core. The paths that intersect the thin ribbon face of the core provide a minimal contribution of induced eddy current losses. For the sake of simplicity these losses will be neglected. Another point of interest is the corners of the core. While one may reasonable assume that these paths do not enter the core at all or at most enter a negligibly small corner of the core, this is not the case. As shown by the flux streamers in FIG. 10A, the flux ‘bends in plane’ around to enter core material in the normal vector. This again agrees with FIG. 7A given that the corner of a core is not an easy path for flux to enter. With the leakage flux paths have been determined and componentized, a new magnetic equivalent circuit can be developed to further understand how the flux path contributes to leakage flux induced eddy current losses.

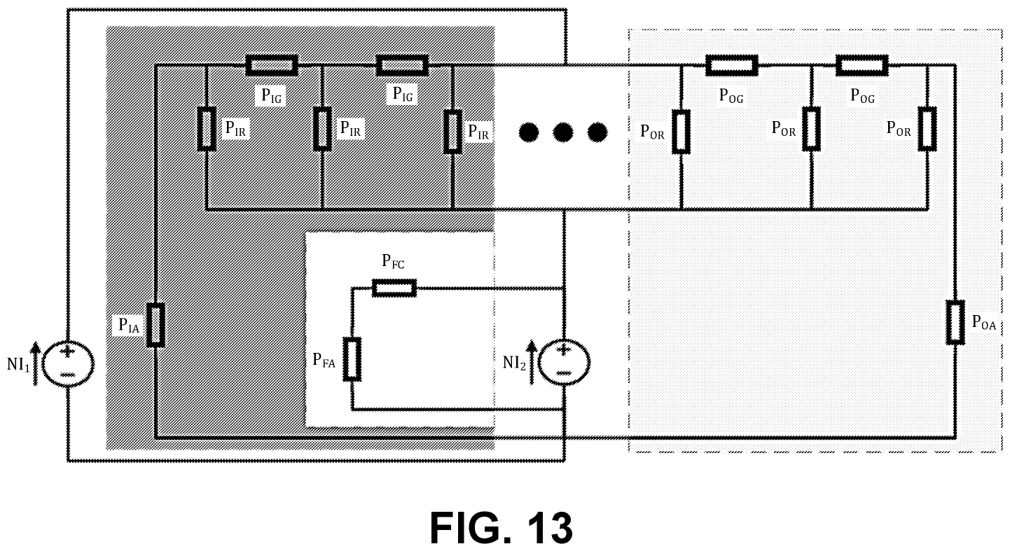

Development of the magnetic equivalent circuit utilizes some assumptions and a nuanced understanding of the likely paths of flux. In general, the total permeance of a path is the series combination of the air permeance and a core permeance. A first assumption is that the permeances of the three segmented paths does not share the same core path nor influences the flux of the others. The inner and outer leakage paths do not share any core material with each other. However, the face path shares core material with both inside and outside. This can be neglected as the face path has significantly more core region to use in between the regions used by the inside and outside paths. Similarly, it is assumed that none of the leakage flux passing through core material exceeds a flux density that would cause saturation. This may not be the case for the outermost ribbon layers due to their thin cross sectional area. However, if the ribbon layer saturates, another is nearby to take the reaming flux. There are many other flux paths but their permeance is either very high or very low and can be simplified as open or short circuit paths. FIG. 13 shows an example of a magnetic equivalent circuit considering componentized leakage paths.

The simplest flux path to define is the face path. This path comprises two permeances, the permeance through air and a much lower permeance through the core. The total permeance is shown in:

$${\hat{P}}_{Face} = {\hat{P}}_{FA} + {\hat{P}}_{FC} = 2 ( {\hat{P}}_{N} + 2 ( {\hat{P}}_{N 2} + {\hat{P}}_{C} + {\hat{P}}_{S} + {\hat{P}}_{Q} ) ) ‖ {\hat{P}}_{FC} = ( \frac{{μ}_{0} {w}_{w}}{π} ln ( 1 + \frac{t}{{h}_{w}} ) + 2 ( \frac{{μ}_{0} t}{π} ln ( 1 + \frac{3 {h}_{C} - h}{2 h} ) + \frac{{μ}_{0} π t}{8 * 1.2 {2}^{2}} + \frac{{μ}_{0} ( 3 {h}_{c} - h )}{48} + \frac{{μ}_{0} π {w}_{h}}{192 * 1 . {3}^{2}} ) ) ‖ \frac{{l}_{e}}{{μ}_{r} {μ}_{o} {a}_{e}} \qquad ( 1.20 )$$

The outside and inside permeance paths also include an air and core combination. However, the flux enters the broad surface of the ribbon. Due to the nature of the geometry there is a high permeability path to return to the coil but it has a very thin cross sectional area. This means that as flux enters the first ribbon layer, some will return to core. However, a significant amount of flux will pass through the gap between layers to the next layer. This results in a latter permeance network where shunt permeances are the ribbon layers represented by R_{R} and the space between layers is a series permeance R_{G}. The ratio between core ribbons and total core area is the fill factor, F. The core has a mean magnetic path of l_{c} and effective cross sectional area of aₑ. The ribbon has a thickness of t_{R}. It is also assumed that the permeance path includes ⅓ of the winding height.

The outer and inner flux paths can be derived similarly. The inner flux path is shown below in:

$${\hat{P}}_{I} = {\hat{P}}_{IA} + {\hat{P}}_{LIC} = ( {\hat{P}}_{B} + 2 {\hat{P}}_{C} ) ‖ {\hat{P}}_{LIC} = ( \frac{{μ}_{0} {w}_{w} d}{{h}_{w}} + \frac{2 μπ d}{8 * 1.2 {2}^{2}} ) ‖ \frac{{\hat{P}}_{IR} + \sqrt{{\hat{P}}_{IR}^{2} + 4 {\hat{P}}_{IR} {\hat{P}}_{IG}}}{2} \qquad ( 1.21 )$$

with \hat{P}_{LIC} being the effective permeance of the latter network. Note that it is assumed that a half cylinder on either side of the window is a flux path where the flux bends to enter the surface inside the window. Where \hat{P}_{IG} and \hat{P}_{IR} are described in:

$$\begin{matrix}{\hat{P}}_{IG} = \frac{{μ}_{0} 2 ( {h}_{w} + {w}_{w} ) d}{( \frac{1}{F} - 1 ) {t}_{R}} & ( 1.22 ) \\ {\hat{P}}_{IR} = \frac{{μ}_{r} {μ}_{o} {t}_{R} d}{2 ( {h}_{w} + {w}_{w} )} & ( 1.23 )\end{matrix}$$

The outer flux path is shown in:

$${\hat{P}}_{O} = {\hat{P}}_{OA} + {\hat{P}}_{LOC} = 2 ( {\hat{P}}_{N} + {\hat{P}}_{C} + 2 ( {\hat{P}}_{S} + {\hat{P}}_{Q} ) ) ‖ {\hat{P}}_{LOC} = 2 ( \frac{{μ}_{0} t}{π} ln ( 1 + \frac{3 {h}_{c} - h}{2 h} ) + \frac{{μ}_{0} π t}{8 * 1.2 {2}^{2}} + 2 ( \frac{{μ}_{0} ( 3 {h}_{c} - h )}{48} + \frac{μ π {w}_{h}}{192 * 1 . {3}^{2}} ) ) ‖ \frac{{\hat{P}}_{OR} + \sqrt{{\hat{P}}_{OR}^{2} + 4 {\hat{P}}_{OR} {\hat{P}}_{OG}}}{2} \qquad ( 1.24 )$$

with \hat{P}_{OG} and \hat{P}_{OR} described in:

$$\begin{matrix}{\hat{P}}_{OG} = \frac{{μ}_{0} 2 ( {h}_{c} + {w}_{c} ) d}{( \frac{1}{F} - 1 ) {t}_{R}} & ( 1.25 ) \\ {\hat{P}}_{OR} = \frac{{μ}_{r} {μ}_{0} {t}_{R} d}{2 ( {h}_{c} + {w}_{c} )} & ( 1.26 )\end{matrix}$$

Using these permeance equations it is now possible determine the proportion of total flux that is associated with each of the three primary paths for the adjacent winding, magnetic ribbon core of FIGS. 12A and 12B. Similarly, the fundamental geometries can be used to assemble the permeance paths and examine the leakage flux division of the other three winding configurations presented in FIGS. 10A-10C or any other winding configuration. Exotic magnetics geometries may need additional constitutive shapes. However, the process of determining the shapes volume and dividing by the mean magnetic path to determine the effective cross sectional area enables limitless designs.

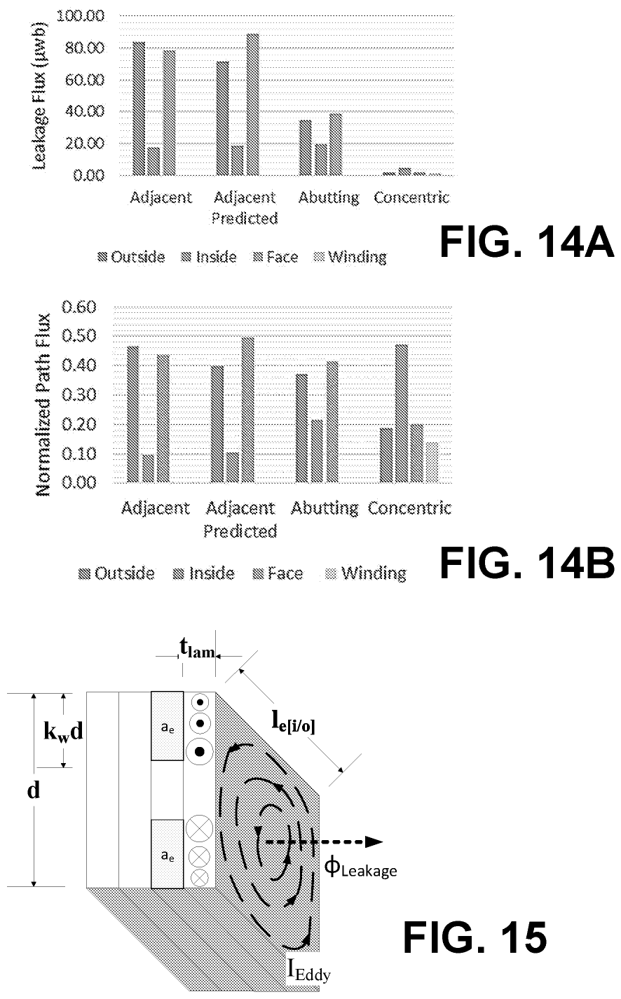

A comparison of the flux breakdown is shown in FIGS. 14A and 14B. These charts tie together the simple geometry permeance models with the geometrically precise Comsol FEA models presented previously. This shows the efficacy of the approach and enables designers to identify the paths that could lead to issues. With these tools, it is easy to take targeted, corrective actions to limit the amount of flux that is on a path that would enter a broad surface of the ribbon.

Induced Eddy Currents in Ribbon

Different physical regions of the magnetic core have different levels of leakage flux approaching the surfaces. For practical cores, all but a minute amount of flux enters the ribbon perfectly normal. Thus, it can be important to determine the induced eddy currents and resulting power losses for each of these regions. Continuing with the adjacent winding core geometry, there are six eddy current loops that could have significant losses. There are negligible loops on the front or back face of the core as the thin profile of the ribbons presents a high resistance path. The first two loops are the top and bottom surfaces of the window. The other four loops are the top and bottom of both the left and right outside surfaces of the core. If the excitation coils are producing flux in the positive z direction, up, then the leakage flux exits from the top window surface and enters the bottom surface. It also exits from the top half of the two outer surfaces and returns by way of the bottom two outside surfaces. Due to symmetry, the six surfaces can be represented by two different eddy current resistances. The outer surfaces can be represented by Rₑₒ and the inner surfaces by Rₑᵢ.

These impedances can be determined using the geometric dimensions shown in FIG. 12A. By definition, the eddy current resistance is:

$${R}_{e} = \frac{{l}_{e}}{{σ}_{R} {A}_{e}} \qquad ( 1.27 )$$

where σ_{R} is the conductivity of the magnetic ribbon that is used in the core. The eddy current path area, Aₑ, for both eddy current loops is shown in:

Aₑ=k_{w}dt_{R} (1.28)

where k is the percentage of ribbon width that is utilized by the induced eddy currents, d is the core depth, ribbon width, and t_{R} is the ribbon thickness. The induced eddy currents generate a magnetic flux in opposition to the leakage flux, see equation Error! Reference source not found.). This opposing flux reduces the changing flux in the center of the ribbon and can result in minimal eddy currents in this region. As such, the eddy current path must be windowed from the total which is served by the k_{w} term. It has been found that 4⁻¹≤k_{w}≤3⁻¹. The eddy current length of the two path geometries is the two resistances diverge. Note that while the flux entering the ribbon is shaded by the excitation coil, the induced eddy currents in the ribbon are not. It can then be assumed that the eddy current loop length exists over the entirety of the top or bottom half surface. This assumption was verified in the Comsol FEA models as well. The outer and inner path lengths are shown in:

lₑₒ=h_{c}+2d(1−2k_{w}) (1.29)

lₑᵢ=2(w_{w}+h_{w}+d(1−2k_{w})) (1.30)

respectively. Error! Reference source not found. 15 illustrates the paths of the stray flux induced eddy currents in magnetic ribbons.

The voltage that is induced in a region by the stray flux into a surface is shown in:

$${ϵ}_{e} = \frac{d {ϕ}_{lr}}{dt} \qquad ( 1.31 )$$

where ϕₗᵣ is the leakage flux for the inner and outer regions determined by the magnetic equivalent circuit defined preciously. Thus the power loss caused by the induced eddy currents for a particular region is:

$${P}_{er} = \frac{{ϵ}_{e}^{2}}{{R}_{er}} \qquad ( 1.32 )$$

For a triangular leakage flux of peak value ϕₚₖ, the total leakage induced losses are shown in:

$${P}_{e - leakage} = {n}_{l} 8 ( \frac{2 {\hat{P}}_{i}^{2}}{{R}_{ei}} + \frac{4 {\hat{P}}_{o}^{2}}{{R}_{eo}} ) {ϕ}_{pk}^{2} {f}^{2} \qquad ( 1.33 )$$

The variables \hat{P}ᵢ and \hat{P}ₒ are the percentage of total leakage flux that enters region, and nₗ is the number of layers of magnetic ribbon material that are involved in this loss mechanism. The number of layers involved has been experimentally determined to be between 1% and 2% of the total core thickness.

Modified Transformer Electrical Model

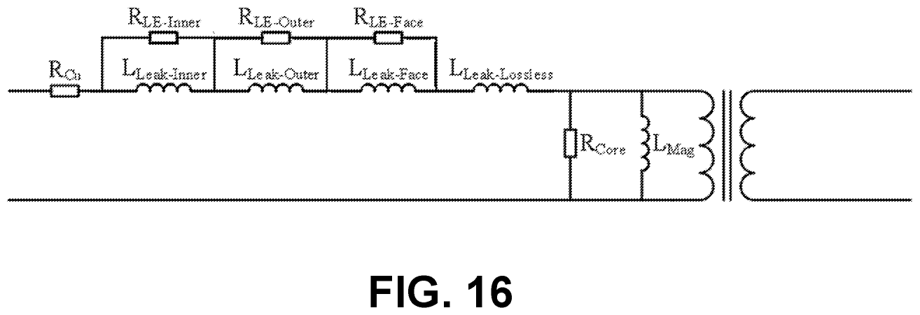

A more nuanced transformer equivalent circuit can be provided by including these concepts. The definition of the leakage paths enables the total homogenized leakage inductance to be separated into several leakage inductances that correspond to a path. The induced eddy current losses associated with these paths can be modelled as resistors in parallel with the path specific inductance. An example of the modified transformer electrical equivalent circuit is shown in FIG. 16. This new model can address any configuration by weighting the inductances and resistances. Continuing with the adjacent winding, wound ribbon example, the inner, outer and face zones can be used while the lossless inductor can be omitted as this geometry has no lossless paths, e.g., between two concentric windings. One advantage of the model of FIG. 16 is that the nuanced leakage model can include several new layers of specificity without impacting other aspects of the model. Similarly, the paths and regions that lead to the most losses can be easily identified as those with a high inductance and a low resistance. Once identified, the problematic zones and paths can be mitigated as will be discussed.

Leakage Flux Control and Loss Mitigation

Careful magnetic design can be used to manage the leakage flux once the critical leakage paths have been identified and the degree to which the total leakage flux is shared among the paths has been determined. There are three primary principals that can be employed to manage and mitigate stray flux induced losses. The first is to limit the magnitude of eddy currents that are generated in the core material by increasing the resistivity. The second is to limit the amount of normal flux that enters the material by reducing the ratio of permeability between the core material and air. The third is to limit the magnitude of leakage flux that enters any ribbons.

Increasing the resistivity of the core is fundamentally a materials problem. Ongoing research into core chemistries, processing continues to improve the resistivity of magnetic ribbons. However, these improvements have been marginal and MANC magnetic ribbons still have relatively low electrical resistivity. One effective way of increasing the resistivity is by crushing the ribbon into a powder and forming a composite magnetic core of binding agents and the crushed material. However, this results in a significantly lower relative permeability because the fill factor of bulk core to crushed powder is very low as there is effectively a distributed air gap. This makes powdered cores poor choices for transformer applications. Ferrites are another core material that is a viable candidate with high resistivity and a relatively high permeability. However, ferrites have a low saturation magnetic flux density and maximum operating temperature. This can make ferrite designs difficult in the high power medium frequency design space. Therefore, increasing the resistivity alone is not a viable solution and in most cases introduces new difficulties in the magnetic component design.

The second approach is to minimize the amount of flux that enters the ribbons normal. This can be achieved with a low permeability gradient as shown in FIG. 7A. All of the leakage flux must complete a loop around the excitation coil. As the flux approaches a low relative permeability core layer, it can enter the core layer at an angle. By entering the core at an angle, only a limited amount of the flux contributes to induced eddy currents. Some of the flux is able to use this low, but higher than air, permeance ribbon to return to the coil. This has the potential for significantly lowering induced eddy current losses. Conceivably, a necessarily large region could have a gradient of permeability that enables enough flux to return to the coil before it reaches higher permeability material.

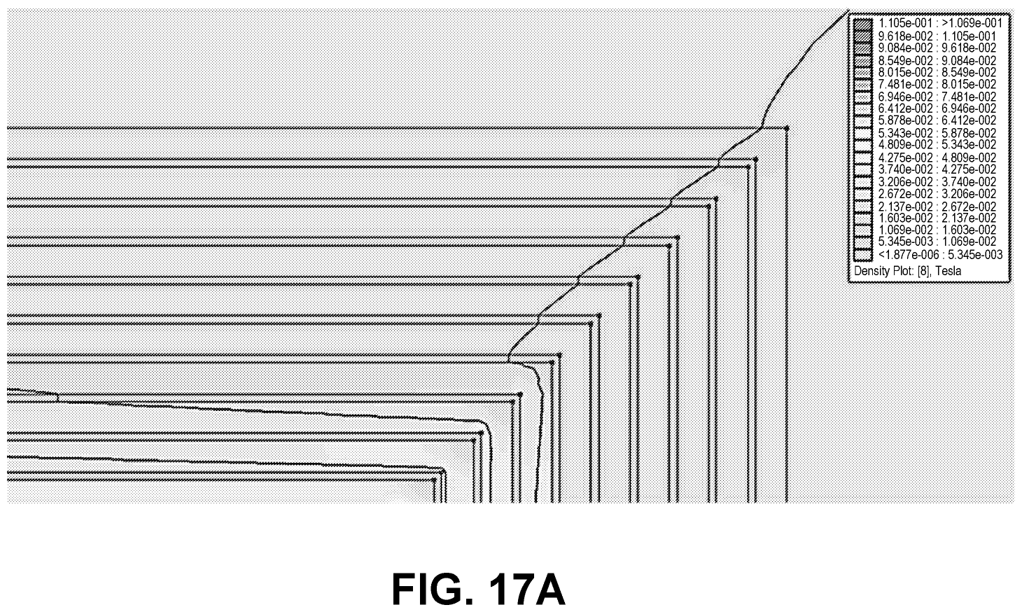

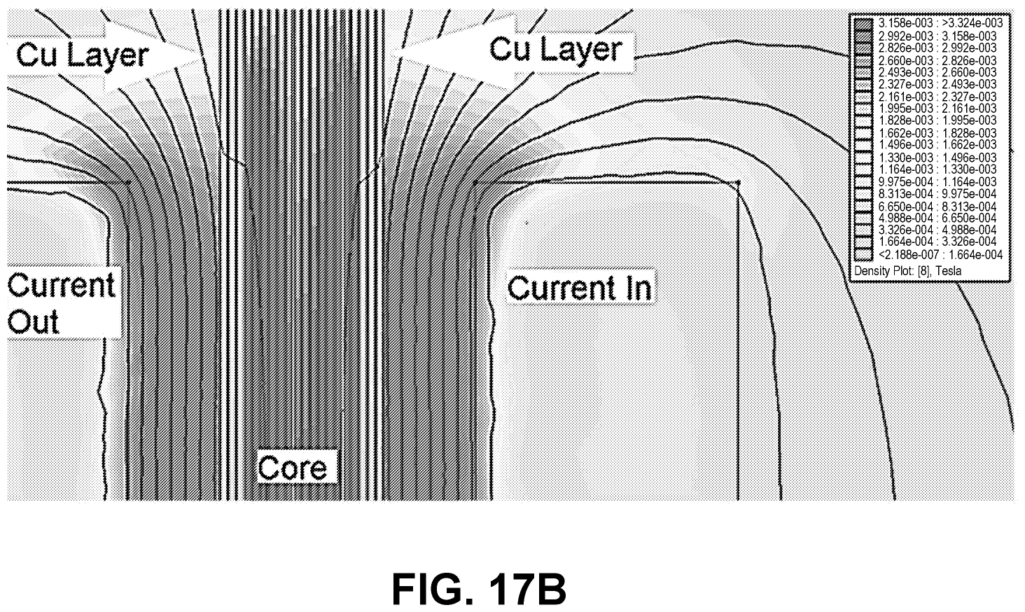

However, if magnetic ribbons are used, this gradient may be impossible as between each layer of ribbon there is an air layer. Thus, regardless of the layer to layer ratio of permeability, there will be a high ratio of permeability between a ribbon and air. A gapless material with graded permeability or a large section of all low permeability layers could be sufficient. An example of graded permeability based normal leakage flux reduction is shown below in FIG. 17A. In this example, the layer to layer permeability ratio is only 8. However, the layer to air ratio is n8 where n is the layer index from the outside layer. The initial layer allows some angled flux but this flux turns normal as soon as it reaches higher boundary ratio layers. Furthermore, the low permeability layers are not sufficient to return the leakage flux to the coil and thus the flux penetrates to much higher permeability ratio ribbon layers.

Alternatively, a highly conductive layer such as, e.g., copper can be used to shield the leakage flux. Rather than minimizing eddy currents, this maximizes the eddy currents such that an opposing flux prevents the leakage flux from passing through. FIG. 17B illustrates the high conductivity based normal leakage flux reduction. Losses are reduced proportionally with very low resistivity with the penalty of higher a I_{eddy}². This approach can result in lower losses with careful design but the loss reduction is minimal. The leakage inductance is significantly reduced because the leakage path must make the entire loop in air instead of partially through the core. This minimizes the practicality of this approach as the leakage inductance is often a necessary design limit.

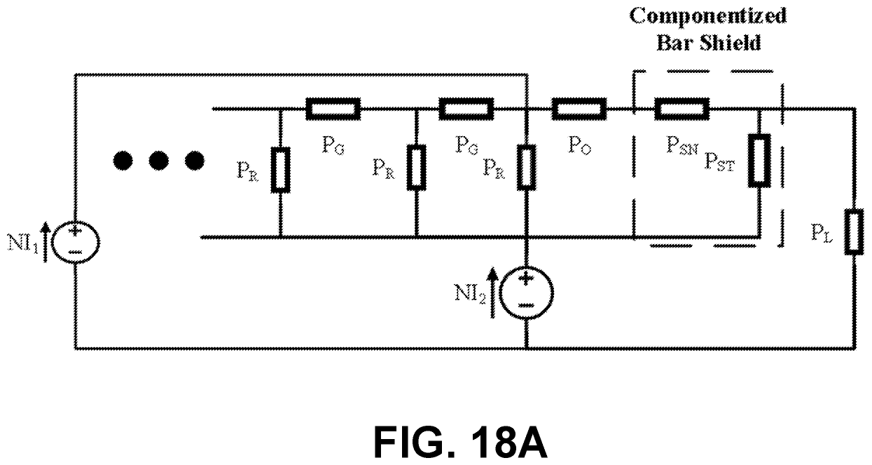

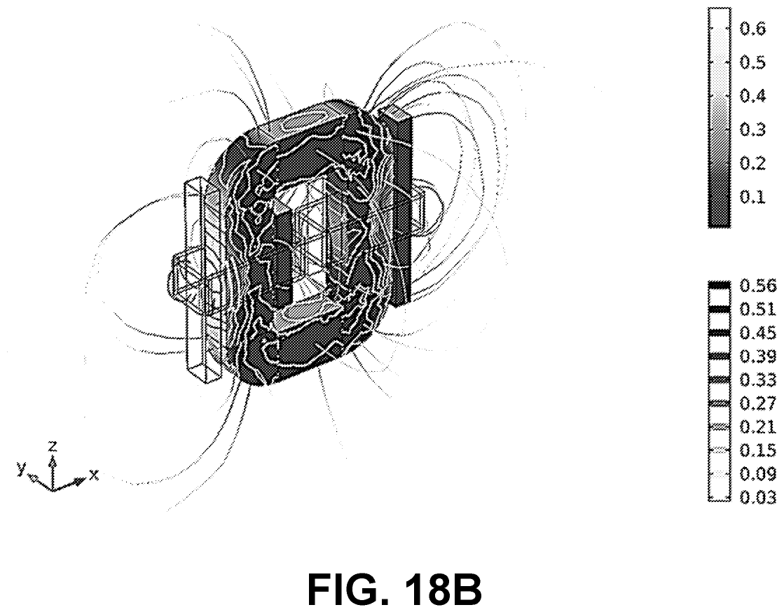

A third way to minimize the losses associated with leakage flux induced eddy currents is to minimize the amount flux that enters magnetic ribbons while keeping it in a high resistivity material. Minimizing the flux entering the ribbon can be achieved by introducing two new permeances to the magnetic equivalent circuit as part of a flux shield component. The first, is a high permeance path that allows flux to return to the excitation coil directly from a leakage path. The second permeance should be low and in series between the magnetic ribbons and the leakage path. This combination of permeances is added as a single shield component in the equivalent circuit of FIG. 18A. The higher permeance path, P_{T}, is tangential to the axis of excitation and the low permeance path, P_{N}, is normal to the core and axis of excitation. It should be noted that the normal flux can be further reduced by having a space between the shield and the ribbon core. This space is represented by P_{O} and can simply be an air space. Given that the shield must handle both tangential and normal flux, it is recommended to use an isotropic material. Ferrite is an ideal material in that is both isotropic and it has a high resistivity. This allows the leakage flux to return to the excitation coil, without entering the magnetic ribbon cores, in a high resistivity region. Assuming that the magnetic core offers an infinite permeance path, the reduction in leakage flux that enters the core can be represented as:

$${ϕ}_{red} = 100 ( 1 - \frac{{P}_{ST} ( {P}_{SN} + {P}_{O} )}{{P}_{SN} {P}_{O} + {P}_{ST} ( {P}_{SN} + {P}_{O} )} ) \qquad ( 1.34 )$$

The first approach available to designing the leakage flux shield introduces minimal change to the overall leakage inductance. This can be achieved by using a bar geometry shield. The permeance paths through air remain mostly unchanged. There is the potential for a slight increase in leakage inductance as the bar can shorten the air path, increase the permeance, of the flux at curved corners. It is recommended to cover as much of the height of the core as possible. The space between the ribbon core and the shield material should be maximized within volume constraints. Thus, the two permeances of the shield and the offset permeance can be given as:

$$\begin{matrix}{\hat{P}}_{SN} = \frac{{μ}_{r} {μ}_{0} {h}_{sh} {d}_{sh}}{{w}_{sh}} & ( 1.35 ) \\ {\hat{P}}_{ST} = \frac{{μ}_{r} {μ}_{0} {w}_{sh} {d}_{sh}}{{h}_{sh}} & ( 1.36 ) \\ {\hat{P}}_{O} = \frac{{μ}_{0} {h}_{sh} {d}_{sh}}{{l}_{o}} & ( 1.37 )\end{matrix}$$

The depth of the shield, dₛₕ, should be at least as deep as the core depth, d. Small variations are acceptable but qualitatively larger dₛₕ is better. Similarly, the height of the shield, hₛₕ should be as tall as the core height, h_{c}. If the shield is placed in the inside window, it should cover as much of the side surfaces as possible, h_{w}. The shield width is flexible and should only be great enough to ensure that the shield does not saturate. Dimensional tuning will aid in shielding performance by decreasing \hat{P}_{SN} and \hat{P}_{O}, and increasing \hat{P}_{ST}.

An FEA model of the bar shield is shown below in Error! Reference source not found. 18B. The surface and contour lines show the normal flux density and induced eddy current density which is normalized to the unshielded case. The reduced peak values of the scales show reduced normal flux and consequently induced eddy currents due to the application of the shield. The nearly lossless flux that interface with the shield are shown with stream lines.

If designers need to increase the leakage inductance or have geometrically independent control of the leakage inductance, a wing shield design can be used. This method of leakage flux shielding fundamentally changes the design process for transformers. Now, the magnetizing inductance and leakage inductance are designed independently. This significantly expands the options and design choices of MANC core materials. Now, the design process should tend towards the following principles. Magnetizing cores should have high relative permeability to proportionally increase the magnetizing inductance. Similarly, the magnetizing core should be uncut to maintain the high permeability and limit layer misalignment induced losses where flux is forced to cross ribbon layers. This misalignment can result in eddy currents at the cut location even if no meaningful gap is present. The shield cores should have a relatively large tuned gap or a tuned permeability. This limits magnetizing flux in the leakage core and enables greater range of leakage inductance values. If the leakage core is gapped, it should have a high resistivity and preferably use an isotropic to accept several incident vectors of leakage flux without excessive induced eddy currents. Strain annealed materials can provide a low perm leakage core without any air gaps or cutting. This contains the leakage flux entirely in the additional core and offers a very wide range of tunable leakage inductances.

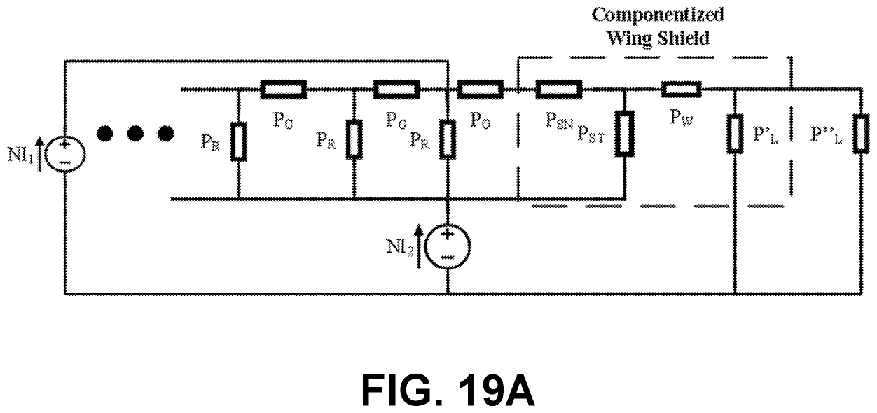

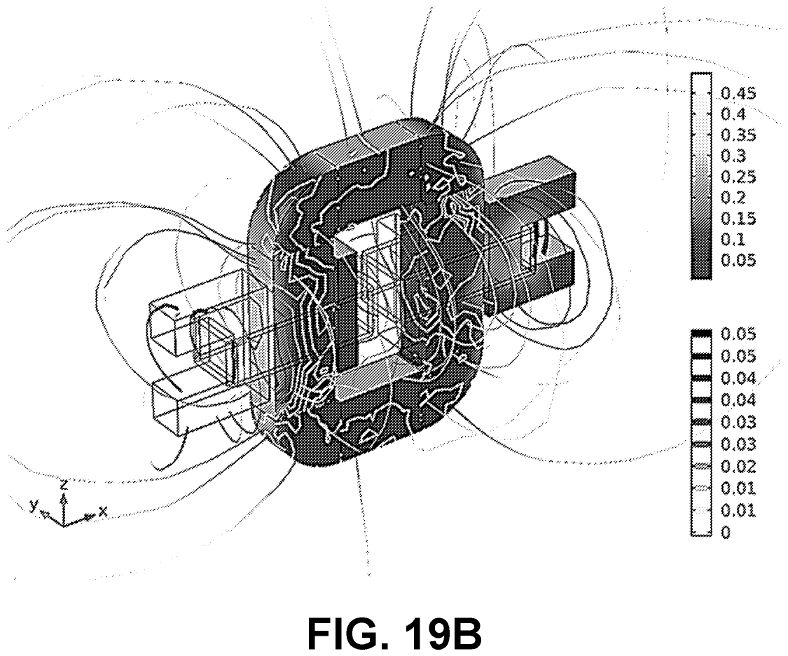

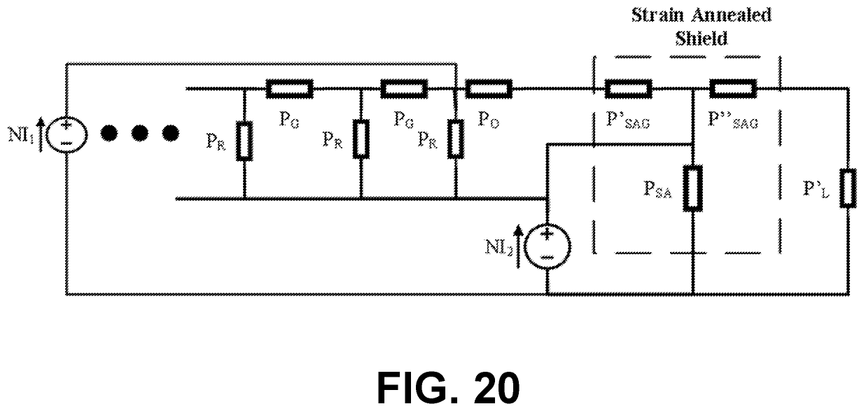

Referring to FIG. 19A, shown is a magnetic equivalent circuit showing permeance paths with a leakage flux wing shield. FIG. 19A illustrates that the wing shield design principal can create a high permeance path that does not include the magnetic ribbon of the main core. However, there are now three new permeances that can be tuned for optimal performance. The first is, P_{W}, the permeance of the wings of the shield. As can be seen in,

$${\hat{P}}_{W} = \frac{{μ}_{r} {μ}_{0} {h}_{w} {d}_{w}}{{w}_{w}} \qquad ( 1.38 )$$

the high relative permeability of the core easily creates a high permeance proportional to the cross sectional area of the wing, h_{w}d_{w}, and inversely proportional to the width of the wing, w_{w}. If the shield has a gap or does not encircle the excitation coil, there is a new air permeance,

\hat{P}′_{L}=Σ [symbol] _{CG} (1.39)

This Permeance depends on the geometry of the wings and wing shield and is the sum of the constitutive geometry permeances, \hat{P}′_{CG}, that are incident with the shield. A third permeance, \hat{P}″_{L}, is also assembled of constitutive geometries:

\hat{P}″_{L}=Σ [symbol] _{CG} (1.40)

and accounts for the air space around the shield. This permeance should be very low as a good wing shield will take up much of the likely flux path space.

An FEA model of the wing shield is shown below in Error! Reference source not found. 19B. The surface and contour lines again show the normalized normal flux density and induced eddy current density. However, these values are normalized to the unshielded case. Therefore, it is clear that the shield reduces the peak values by the maximum values of the scale. The stream lines are flux paths that interface with the shield are effectively lossless paths. If an uncut strain annealed shield material is used, \hat{P}′_{L} is the constituent geometries around the face of the shield core and \hat{P}″_{L} would be minimal. The independent design of magnetizing inductance and leakage inductance could be achieved by, respectively:

L_{mag}=N²\hat{P}_{core}∝μᵣ (1.41)

Lₗₑₐₖ=N²\hat{P}_{SA}∝μ_{SA} (1.42)

where the magnetizing core has relative permeability of μᵣ and the strain annealed core has a relative permeability of μ_{SA} and μᵣ>>μ_{SA}.

This approach to integrated leakage inductance design is advantageous over other methods. This is because in all cases, the leakage flux flows along an easy axis. In other cases, the flux was redirected within the ribbon leading to a hard axis flux flow. At the connection point, the low permeance joint causes behavior similar to that of an air gap leading to stray and fringing fields. Furthermore, this solution and derivation analytically determines where leakage flux is most problematic, which allows for targeted solutions.

Leakage Flux Shield Penalties

While the leakage induced eddy currents constitute a significant loss that is mitigated by shielding approaches, this solution is not without loss penalties. There is a small increase in the copper resistance due to the increased perimeter of the core and shield. This proportionally increases the excitation coil conduction losses. However, utilizing an uncut magnetizing core with a high saturation flux density, like most magnetic ribbon materials, allows for a low number of necessary turns. This means that the unshielded design excitation resistance is minimal and the increase due to shielding will also be relatively small. With shielding materials there is also an increase in magnetization losses. These losses will also be low because of low levels of flux in the flux path. The flux concentrating effect may lead to higher magnetizing losses in the shield. However, these increases in losses are minimal compared to the reduction in leakage flux related losses.

### EXPERIMENTAL RESULTS

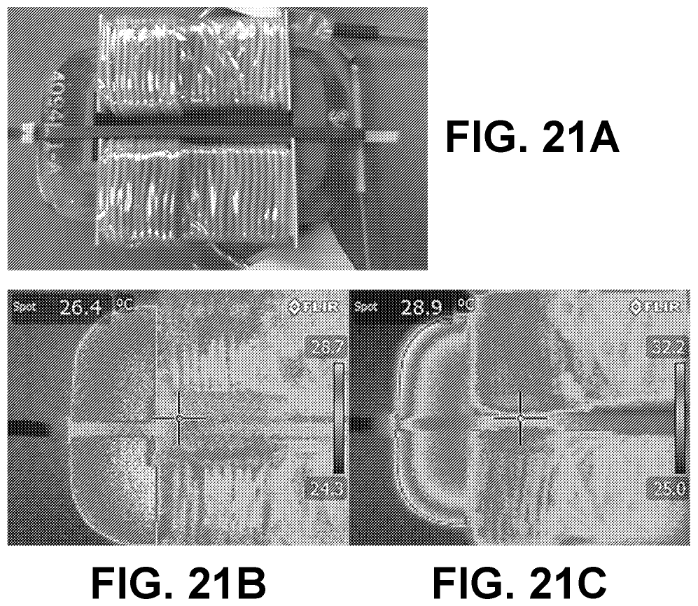

It is difficult to directly observer eddy currents and transformer localized losses. Rather, indirect methods such as thermal imaging allow observers to see the effect of localized losses. Due to the thermal anisotropy of the core, thermal gradients can local hot spots can aid in identifying local losses. An example of this is shown in FIGS. 21A-21C, which compare the magnetizing and leakage test thermal profiles for the transformer of FIG. 21A. FIG. 21B shows the thermal profile of standard open secondary test used in core characterization. As expected, the hottest part of the core is in the innermost ribbon layers. This may be attributed to the concentration of magnetizing flux in the high permeance path. FIG. 21C shows the thermal results of the same transformer with the secondary shorted. This short circuit test forces the vast majority of the magnetic flux through the leakage paths of the transformer. In both cases the time and excitation current level were held constant. FIG. 21C highlights the leakage flux induced eddy currents as observed by heating of the outer most layers. Magnetizing flux is not present in these layers as the mean magnetic path reduces the permeance compared to the inner most layers.

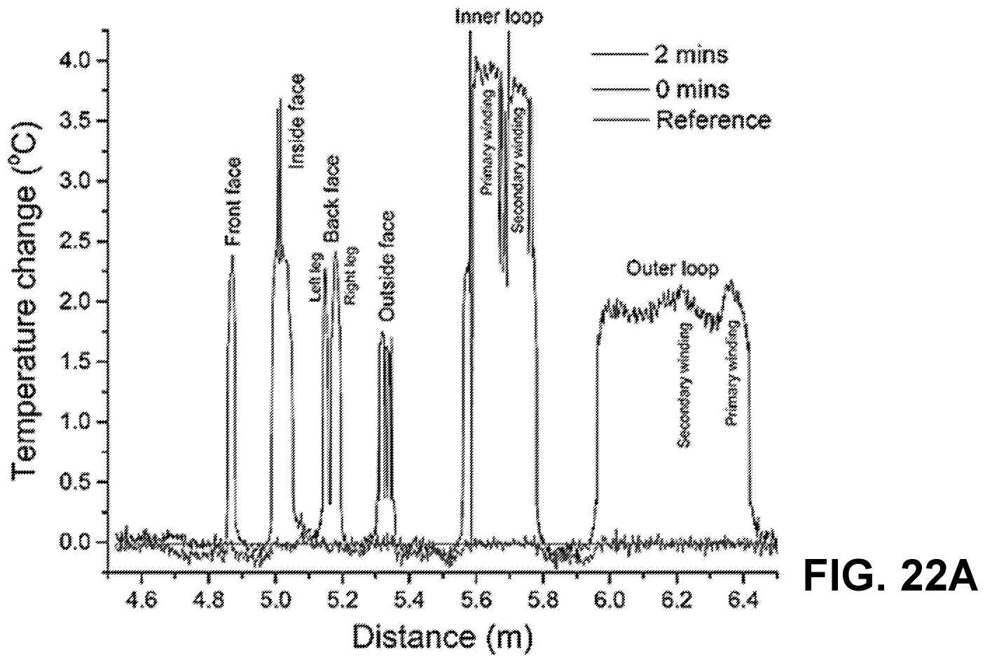

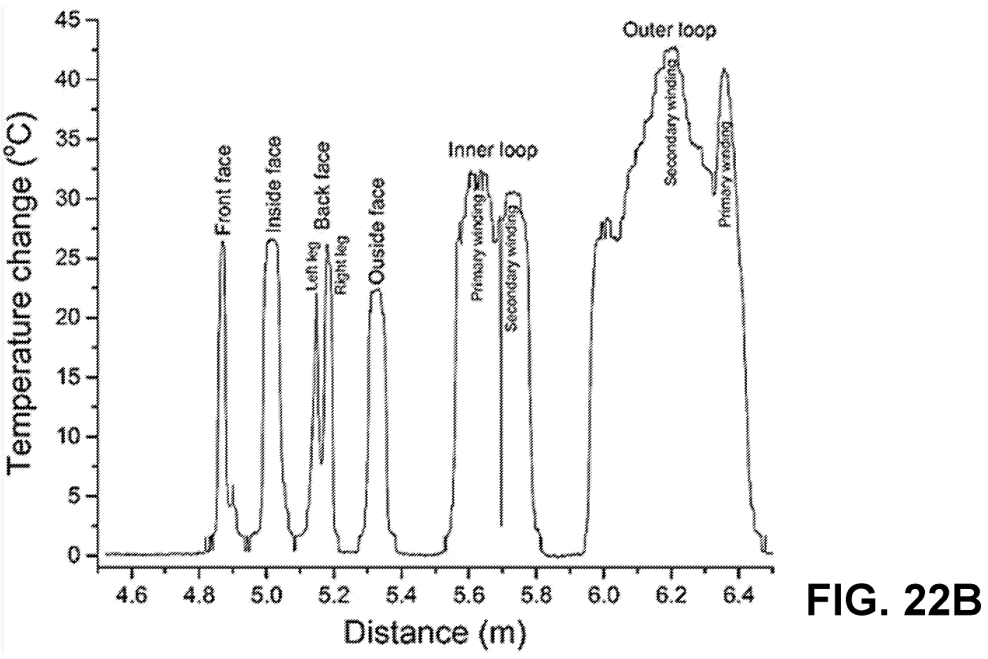

Fiber Optic Thermal Mapping. A similar result using an advanced fiber optic line scan sensing technology is shown in the optical line scan measurements for magnetizing and leakage tests in FIGS. 22A and 22B. This sensor overcomes some of the limitations of thermal imaging of shiny metallic surfaces as the sensor does not rely on emissivity. Rather, the thermal energy causes distortions in the optical properties of the fiber optic cable which in turn change the backscattering profile of the sensing light. This can then be interpreted as changes in temperature from the ambient temperature. Another MANC magnetizing core was subjected to open and shorted secondary tests with a length of fiber optic cable woven around various locations on the core. The cable was wrapped around both the outside and inside layers of the core. FIG. 22A shows the magnetizing result tests. Again, the inside layers of the core were hottest. FIG. 22B shows the results of the short circuit test, now with the outside layers being the hottest. Again the losses associated with the leakage paths are isolated and confirmed.

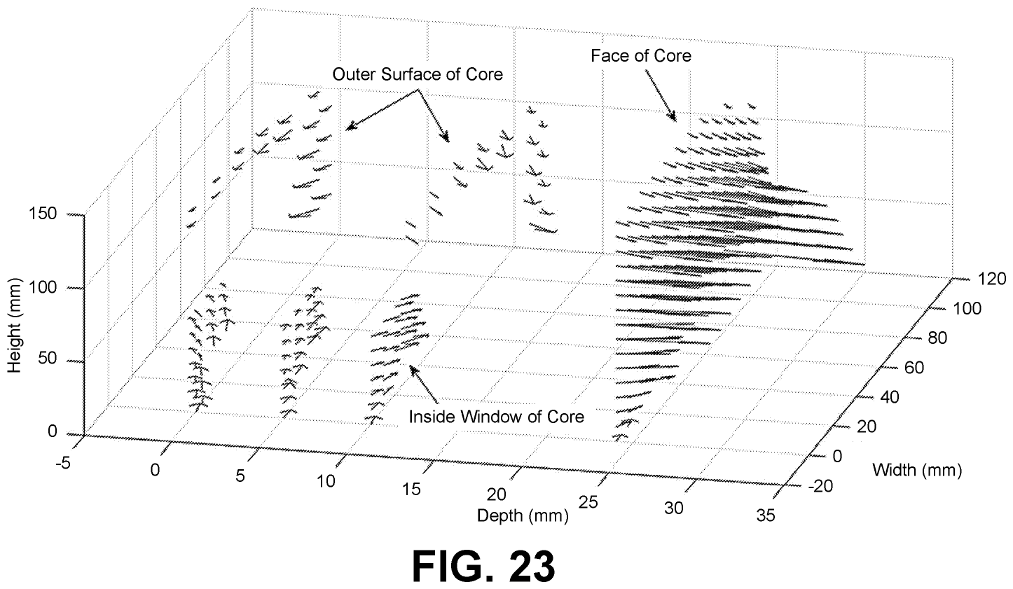

Three Dimensional Flux Mapping. As shown in the FEA models, the flux emanates from the excitation coil like a catenoid. This shape and the idea that all flux entering magnetic material from air enters normal to the magnetic material may be observed. In order to do this, a three axis location meter was assembled. This involves fixing the location of the magnetic core and then measuring the two offset from this point to achieve a coordinate in the XY plane. The location in the Z dimension was determined using a height gauge. In order to enable measurements inside the window of the core, the sensor arm was adjustable on a single axis. A three dimensional leakage flux map was developed using a three axis flux meter from GMW. FIG. 23 illustrates an example of the measured leakage flux field around the transformer. In this test, the core was subjected to 0.1 T at 10 kHz in a short circuit test. Measurements were taken in the upper right octant of the transformer. The effect of various regions of the core can be seen.

Adjacent Winding Case Study. An example case study is presented with the model development and testing of a transformer design that can be used in a dual active bridge. For this example, the transformer was chosen to have a fundamental switching frequency of 10 kHz, a peak operating power of 10 kW and a peak operating voltage of 355 VDC. Some design aspects are deliberately chosen as non-optimal in order to highlight the leakage flux based losses and improve understanding. An off the shelf nanocrystalline Finemet FT-3TL core was chosen as the magnetic core with no additional manufacturing processes. The product code for the specific geometry is F1AH1171 and specific dimensions and values available from the product literature. This analysis will use generic symbols as much as possible to improve the usability of this example.

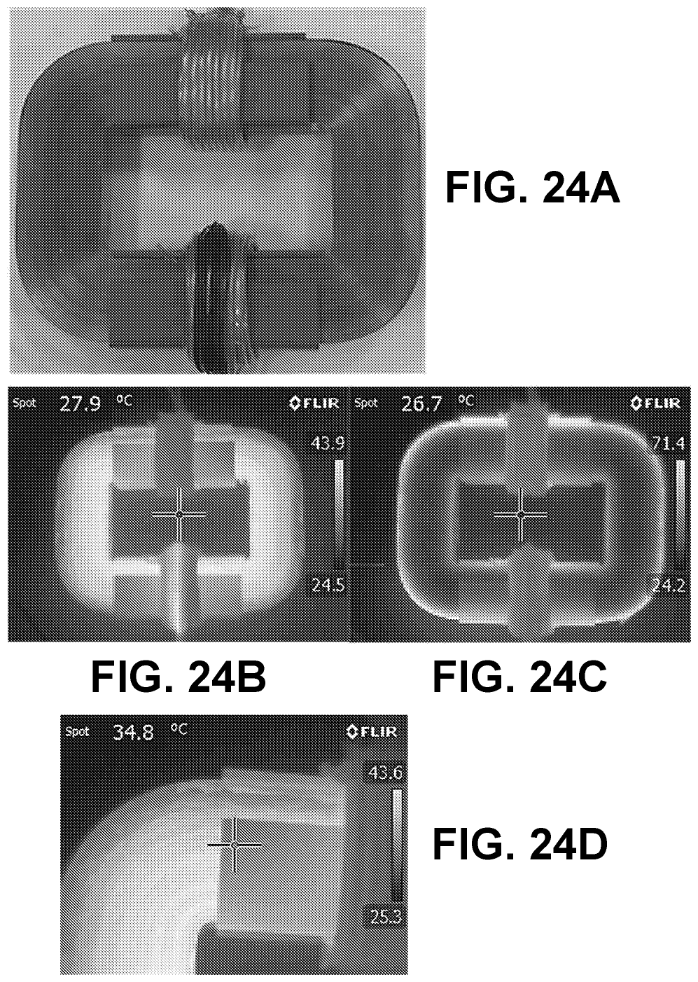

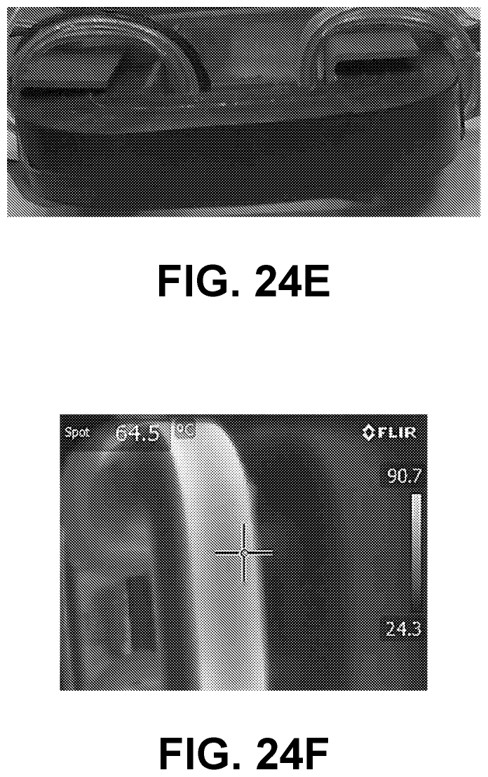

FIG. 24A is an image of the unshielded 15:15 turn, adjacent winding configuration, similar to the design in FIG. 10A, that was used in this case study. By these design parameters, the traditional analysis would observe that the transformer operating point is at a maximum of 0.53T, resulting in 86.2 W of loss or a 99.2% efficient design. Furthermore, the leakage inductance of 157 μH and 12 mH magnetizing inductance is in the range typical of dual active bridge designs for the aforementioned specifications.

The thermal image of this core in the open secondary (magnetizing) test is shown in FIG. 24B. This thermal image was taken after 15 minutes of exciting the core at 0.2T. Then, the excitation level and frequency was swept over a range of 0.1 T to 1 T and 10 kHz to 50 kHz. The excitation level was curtailed at higher frequencies due to limitations of the DC power supply. The enlarged image in FIG. 24D highlights the magnetizing flux thermal profile. It is clear from these images that the interior of the core is the hottest. Similarly, there are losses distributed throughout the core. This is because magnetizing flux is exciting all of the magnetic ribbon layers, leading to excitation loss.

This same core was also tested with the secondary shorted. In this leakage test, the thermal image in FIG. 24C was taken after 15 minutes of exciting the core at 0.2 T. However, this magnetic flux was through the leakage paths. In this case, it is clear that the outer most layers and the inner most layers of ribbon are contributing to losses. This is expected as this design is similar to FEA models above where there are significant amounts of leakage flux entering the outside ribbon layers and in the window of the transformer.

Observing the thermal profile of the side of the transformer also yields interesting results. The top view image, showing the broad surface of the ribbon, is shown in FIG. 24E. It can be seen from the leakage test thermal profile of FIG. 24F that the hottest regions of this outermost layer are along the edges. It is also clear that the very top is cooler than the surfaces closest to the windings, top of the thermal image. These effects correspond to the concentration of eddy currents around the perimeter of the surface, accounted for with the k_{w} term that affects the area of the eddy current path in equations Error! Reference source not found.), Error! Reference source not found.), and Error! Reference source not found.). This is really accounting for the second order effects of flux cancelation as described in equations Error! Reference source not found.) and Error! Reference source not found.).

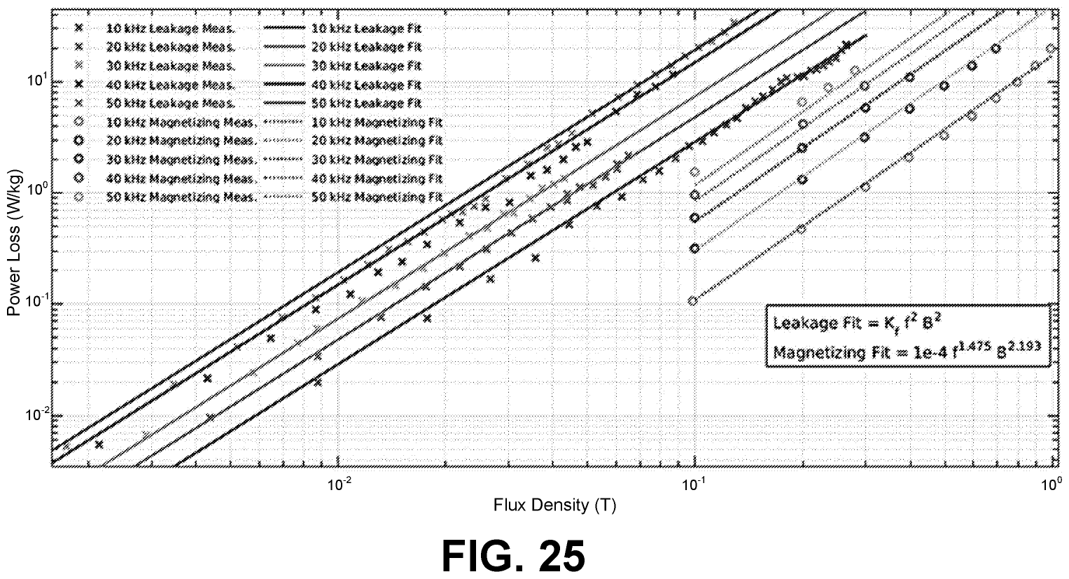

A summary of the recorded magnetizing and leakage losses is shown below in FIG. 25. Measured data is recorded as points, ‘x’ for leakage and ‘o’ for magnetizing. First the magnetizing losses were recorded. Second, a current loss lookup table was created for the conduction losses of the primary coil. The leakage losses were determined by taking the average power of the instantaneous voltage and current in the primary winding. Then the conduction loss, I²R, and magnetizing loss for that excitation level were subtracted out. It is clear from both the measured data and the fit lines that leakage inductance based losses are significantly higher than the magnetizing losses, 20 to 30 times higher. These newly characterized losses represent a significant loss mechanism that greatly limits the ability to successfully design high power medium frequency transformers. As power is transferred through the leakage path, the induced eddy currents will introduce a previously unaccounted for power loss that will dramatically lower system efficiencies.

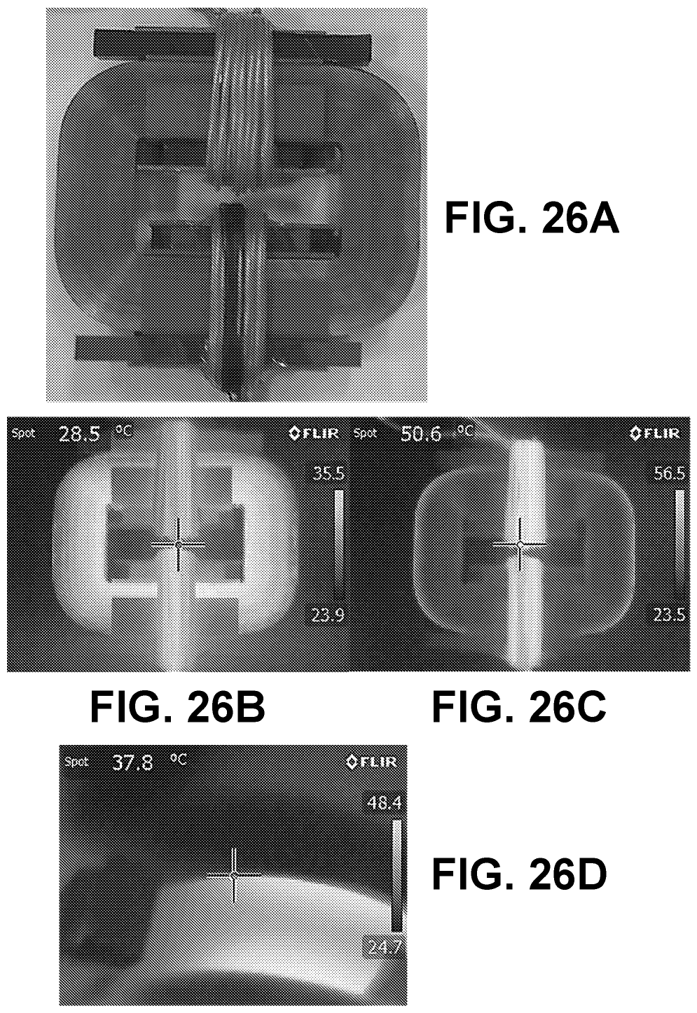

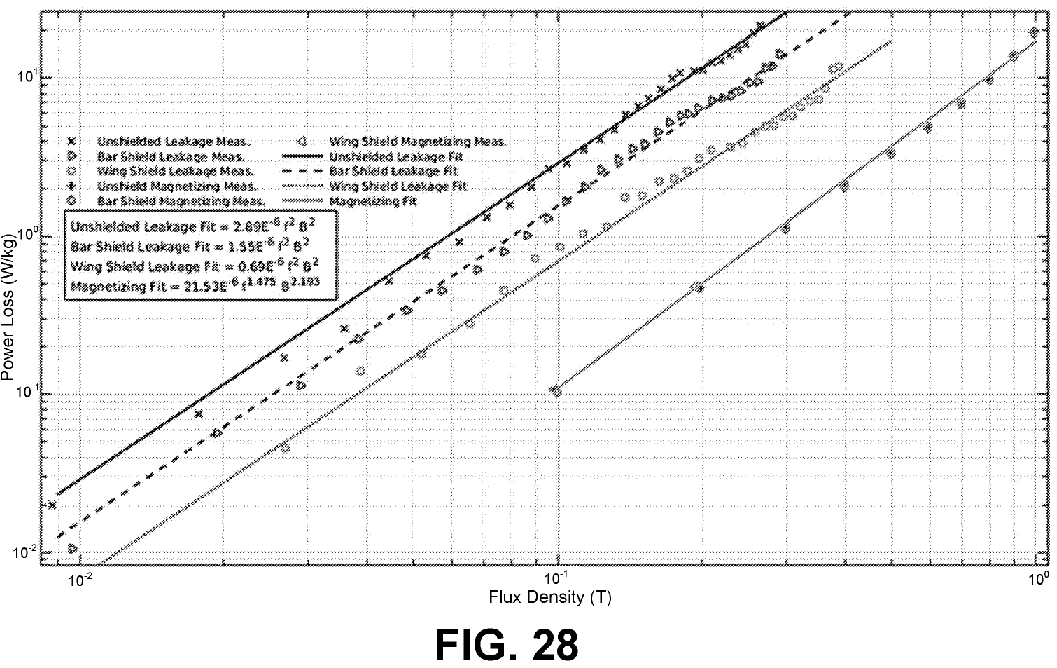

The bar shield is a simple approach to minimizing leakage flux losses that has a minimal impact the overall core performance and design. An example bar shield was assembled using Ferroxcube 3c95 ferrite ‘I’ cores, as shown in the image of FIG. 26A. Two cores were connected together to form the outer shield while a single bar forms the interior. As a laboratory prototype, off the shelf bars were used. In a formal design, specific dimensions that fit the core would provide better performance. It is clear from the magnetizing thermal image of FIG. 26B, that the bar shield has minimal impact to the magnetizing behavior of the transformer. However, in the leakage test, the thermal image of FIG. 26C shows that the transformer runs significantly cooler. Rather than the edges of the core being the hottest spots as is the case in the unshielded design, the bar shield enables the transformer core to stay cooler than the exciting coils. It is clear that the bar shield is redirecting leakage flux away from the magnetic ribbons and is thus minimizing stray flux induced eddy currents. It can also be seen in the enlarged image of FIG. 26D that the top layer of the core is running cooler. The core is coolest closet to the shield where minimal flux is entering the ribbon. Away from the shield, the core is hotter and exhibits a hot edge around the perimeter, similar to the unshielded case. This reduction of eddy currents is clearly shown in the reduced losses shown in the loss map of FIG. 28.

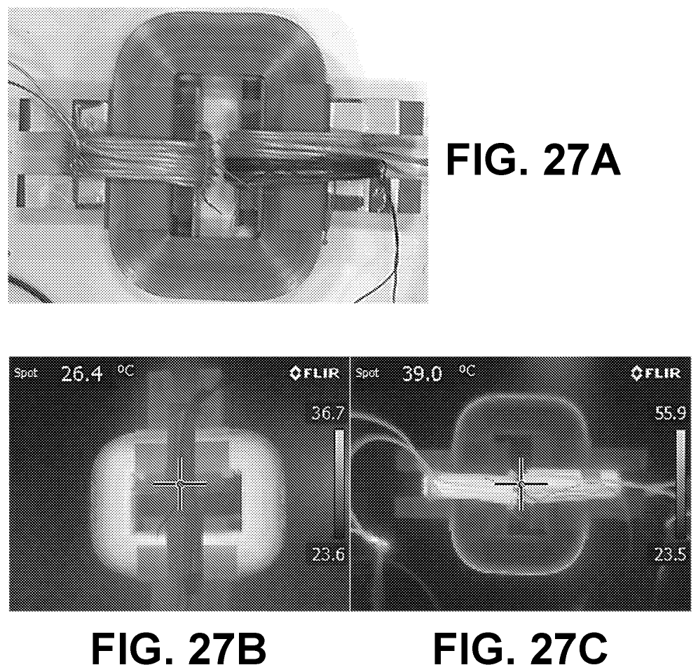

The next shielding design presented is the wing shield, which is shown in the image of FIG. 27A. The bar shields remained Ferroxcube 3C95 however only C cores of 3C90 were available in suitable dimensions. The wings that were used extended outward nearly 3× the winding thickness. There is still a significant air gap however and the extension length could be shortened with a shorter air gap design. This design was also subjected to a 10 kHz leakage and magnetizing loss measurement sweep.

As can be seen from the thermal images of FIGS. 27B and 27C, the wing shield showed similar thermal results to the bar shield. The magnetizing test image in FIG. 27B, shows minimal, if any impact to the magnetizing test thermal profile. The leakage test image in FIG. 27C shows a significant reduction in outer and inner ribbon heating. This thermal profile proves that the wing shield is a viable solution to increasing the transformer efficiency while gaining independent leakage inductance design flexibility.

The loss measurements for the three design cases, unshielded, bar shielded and wing shielded are shown in FIG. 28. The three fit lines for the leakage losses were all found to fit the expected form for classical eddy current losses. The three magnetizing tests resulted in nearly identical measurements and so only one fit line is presented. This line also fits nicely with a Steinmetz like equation. It should be noted that the magnetizing loss coefficients are not the traditional Steinmetz coefficients because the core was subjected to triangular excitation.

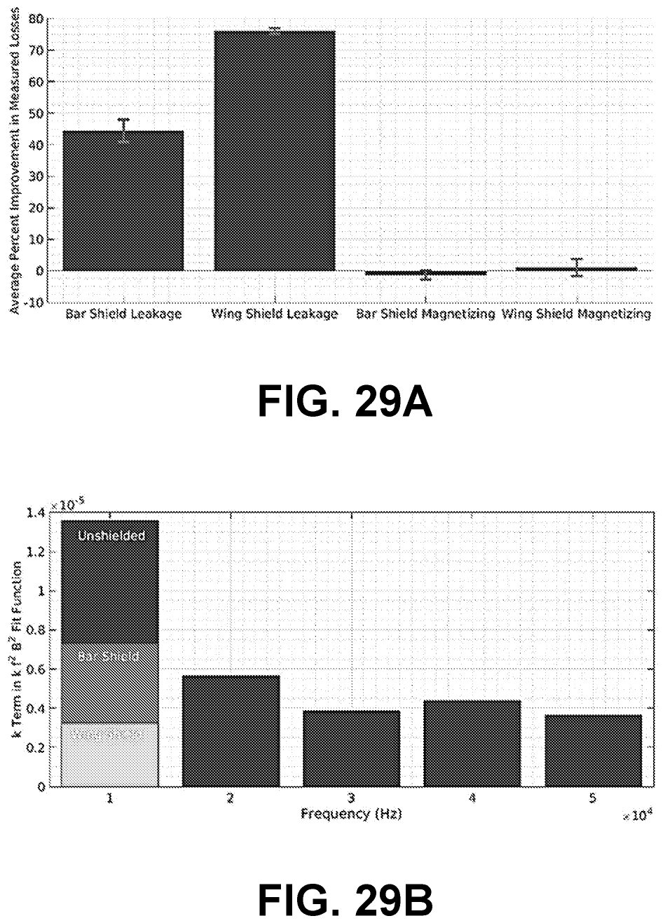

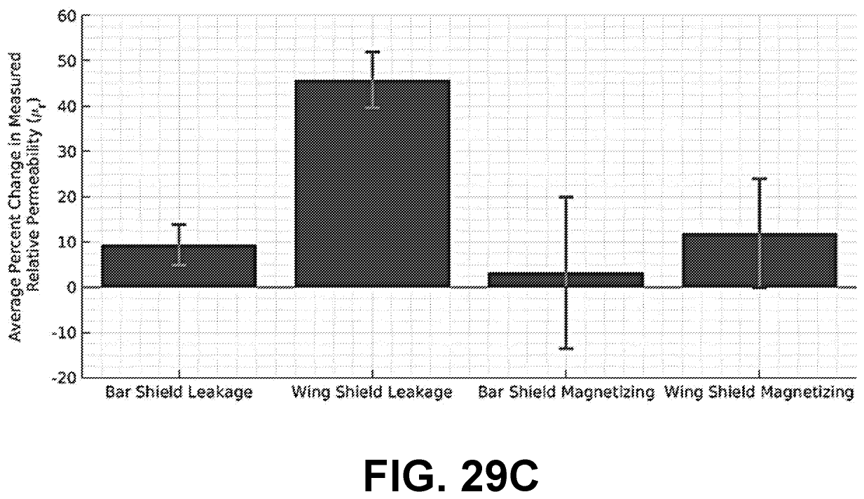

It is evident that the shielding approaches provide a significant reduction in leakage losses. These leakage losses are still higher than the simple magnetization losses. However, more deliberate shield design with specially designed ferrite geometries could reduce these leakage losses even further. In these shield designs, the shield was found to reduce the amount of flux into the ribbon by nearly half. FIG. 29A is a bar chart illustrating loss reduction in the shielded designs. These tested designs were able to reduce the leakage losses by roughly 45% and 75% for the bar and wing designs respectively while minimizing the impact on the magnetizing losses. Loss variations less than 5% are within the sensor tolerances. Further geometry and design refinement could reduce this stray field even further thus potentially providing core designs that are as efficient through the leakage path as the magnetizing path.

A similar solution comparison is the reduction of the leakage loss k value for the different shields and frequencies is shown in FIG. 29B, where it is clear that both the bar and wing shield provide a significant loss reduction over a design with no shield. The reduction of k values through shielding is convenient for comparison between designs and curve fitting. However, what the shields are actually doing is reducing the amount of flux generated by the excitation coil that enters the broad surfaces of the ribbon. Therefore, an alternative way to look at the wing shield efficacy is by the effective ribbon flux reduction. This is shown in

$${ϕ}_{PR} = 100 \frac{( \sqrt{\frac{{k}_{none}}{{k}_{sh}} -} 1 )}{\sqrt{\frac{{k}_{none}}{{k}_{sh}}}} \qquad ( 1.43 )$$

where kₙₒₙₑ is the k term of the unshielded induced eddy current loss fit line. The k term for either the bar or wing or some other future shielded loss fit function is kₛₕ. Using this analysis, the bar shield reduces the apparent normal flux by 27% and the wing shield reduces the flux by 51%.

How the shielding changes the leakage and magnetizing inductances was also examined, as shown in FIG. 29C which illustrates this impact to permeability. It is clear that the bar shield has a minimal impact on both leakage and magnetizing inductances enabling it to be a direct addition to a current magnetics design. The wing shield however, significantly increases the leakage inductance. This increase indicates that by utilizing wing shields, shields with gaps or strain annealed ribbon shields, the leakage inductance can be tuned independently of the magnetizing inductance. This enables significant design simplification where a tight leakage inductance design is needed such as in the active bridge converter.

Leakage Integrated Transformer for Two-Port Dab Converter

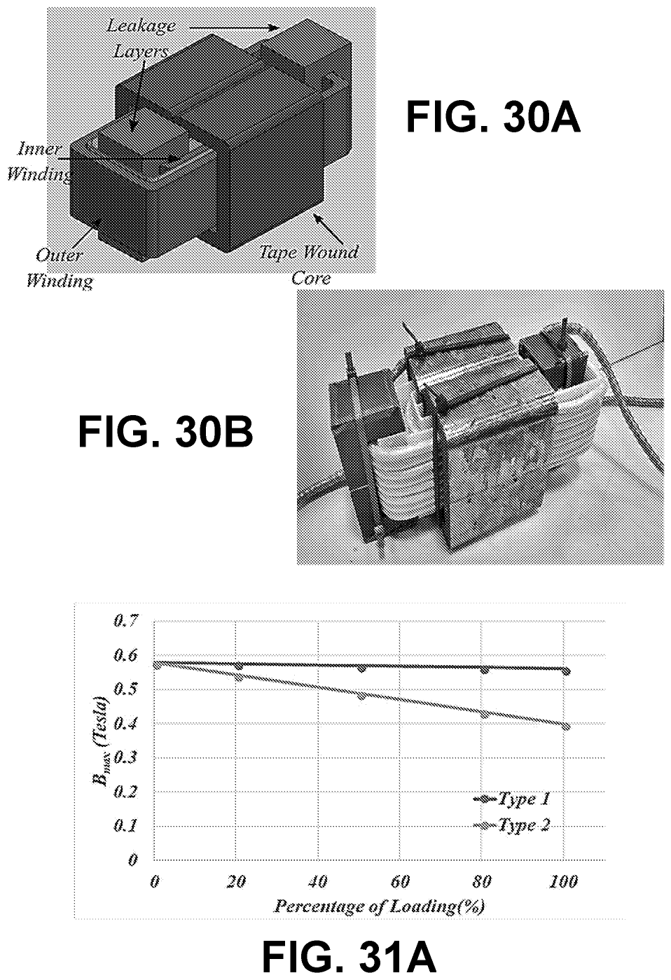

An arrangement for a leakage integrated transformer was examined for a concentric winding type transformer with three limbs. This arrangement can reduce the eddy current losses in the core, but also reduces the total reluctance in the magnetization path of the tape wound transformer core. In the concentric winding arrangement, the leakage layers are placed in the front side and back side of the transformer, such that the leakage flux is reduced over the tape wound core window volume. FIG. 30A is a graphical representation of a type 2 transformer with integrated leakage shielding and FIG. 30B is an image of a prototype of the integrated transformer used for experimental testing.

In this arrangement, the inner winding passes through the window on one set of leakage core and the outer winding passes through the outer core window. The two leakage layers are independent of the fluxes in each other and no induced flux from one winding links to the other winding through the leakage cores. The induced flux from one winding to the other links through the nano-crystalline cores. The leakage cores have an air gap which determines the leakage inductance of the transformer. Placing the leakage layer cores on both inner & outer windings reduces the induced peak flux density with increasing phase shift & loading. As can be seen, the leakage shielding can be located between coils of the device and/or between a coil and the ribbon core of the device.

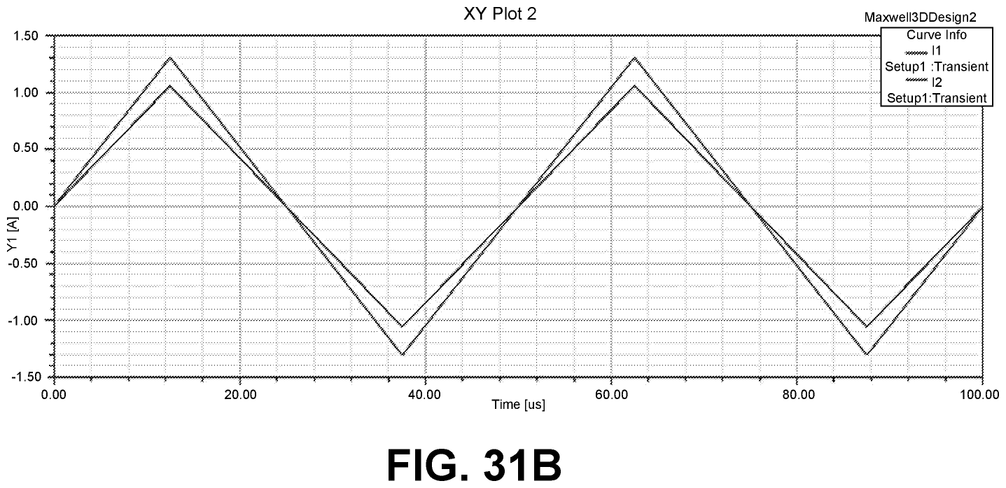

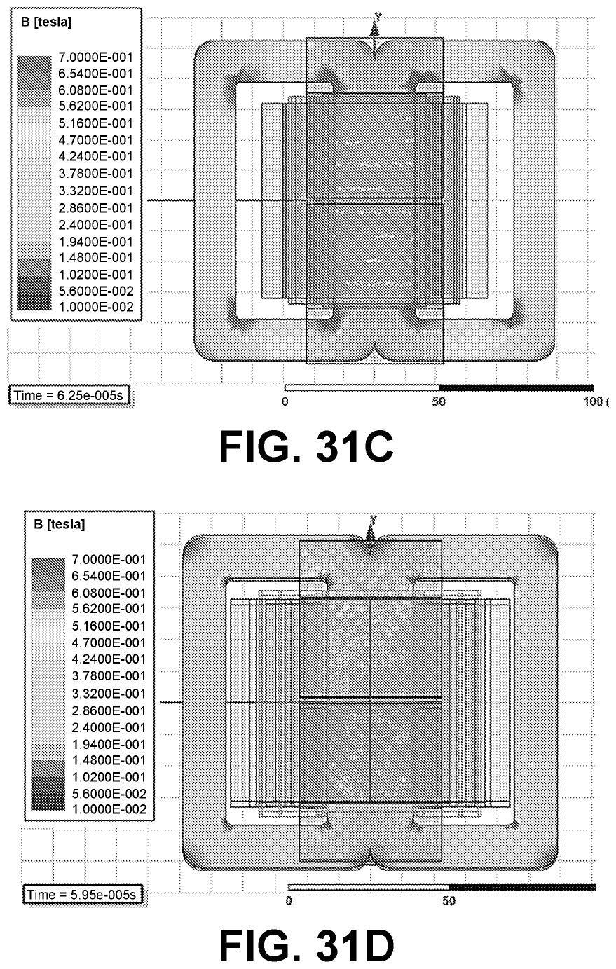

FIG. 31A show the peak flux density as it varies with loading, and FIG. 31B shows the no-load winding currents for the integrated transformer of FIG. 30B. FIGS. 31C and 31D illustrate the peak flux density in the integrated transformer core under no-load and full load conditions, respectively. It can be observed that the no-load peak flux density in the tape wound core is the same (around 0.58T) for both the transformers but the full load peak flux density is much lower for a type 2 transformer (around 0.4T) compared to a type 1 transformer (around 0.56T). The effect of this drop in peak flux density with increasing load in the type 2 transformer results in lower core losses.

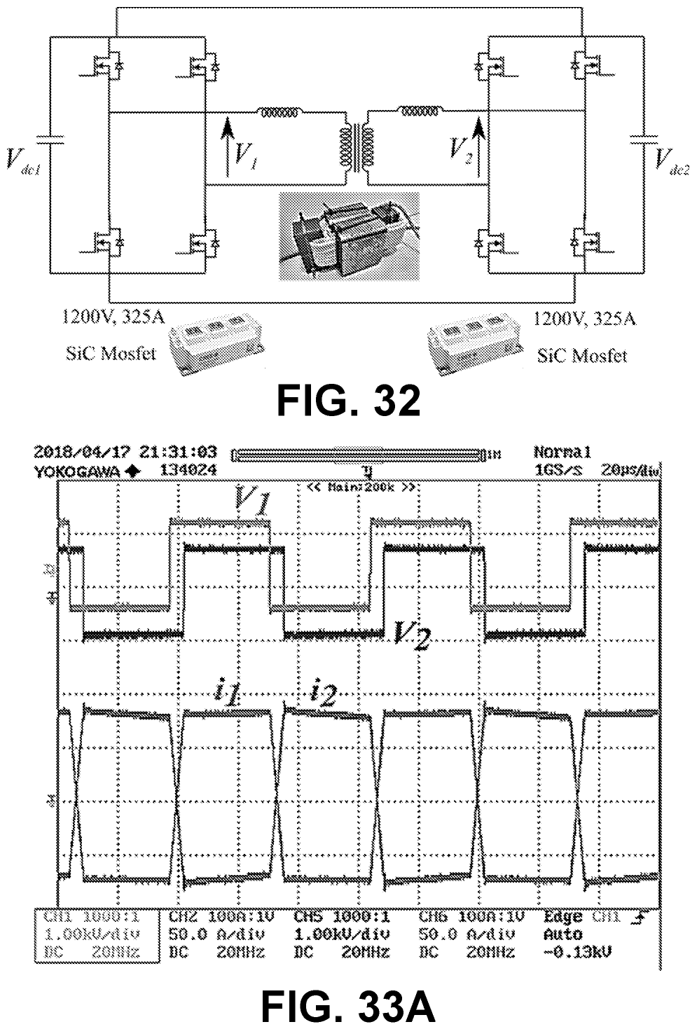

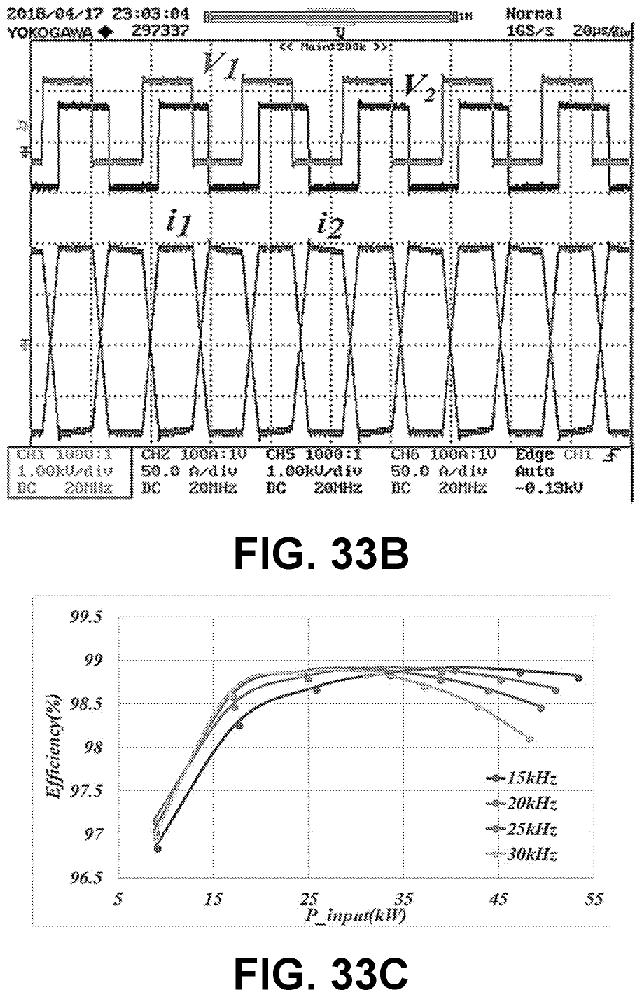

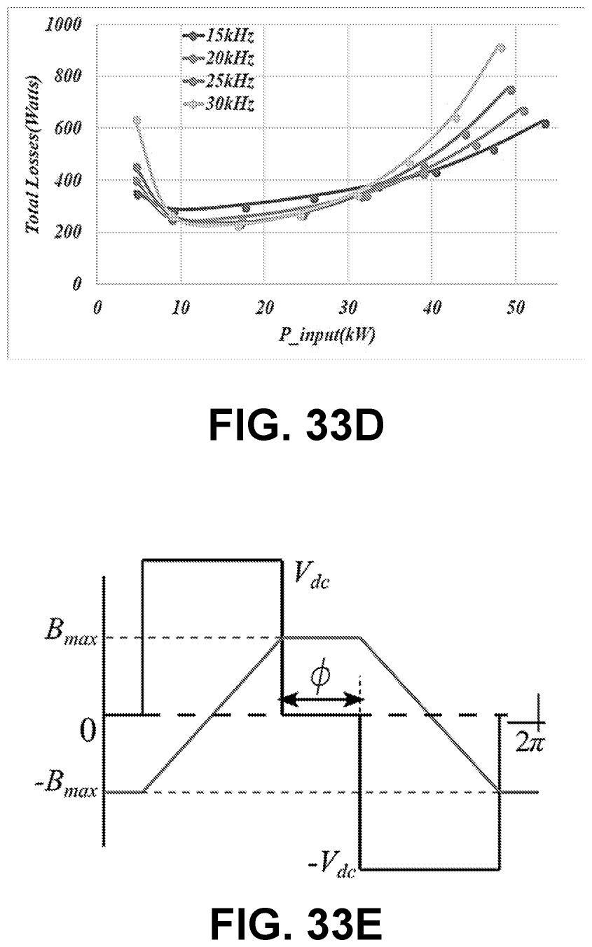

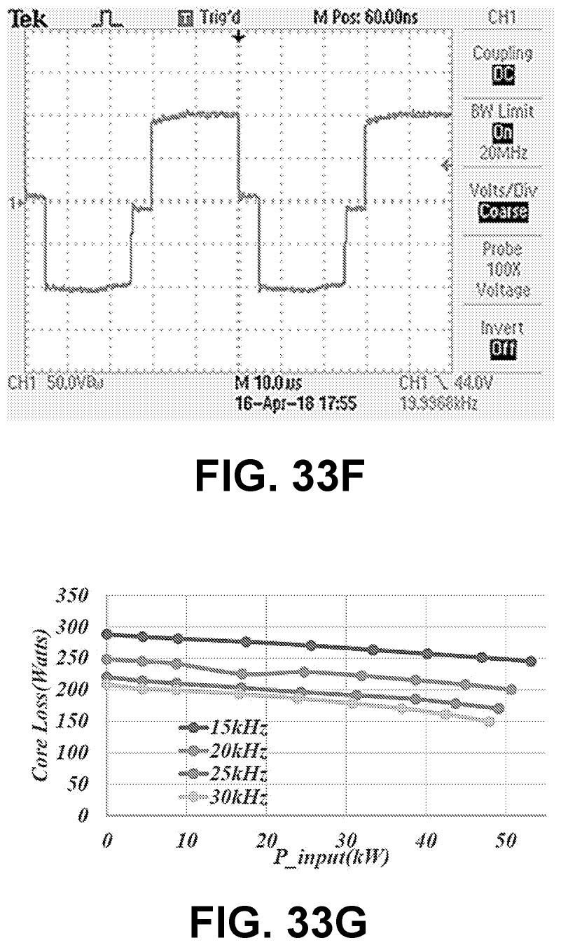

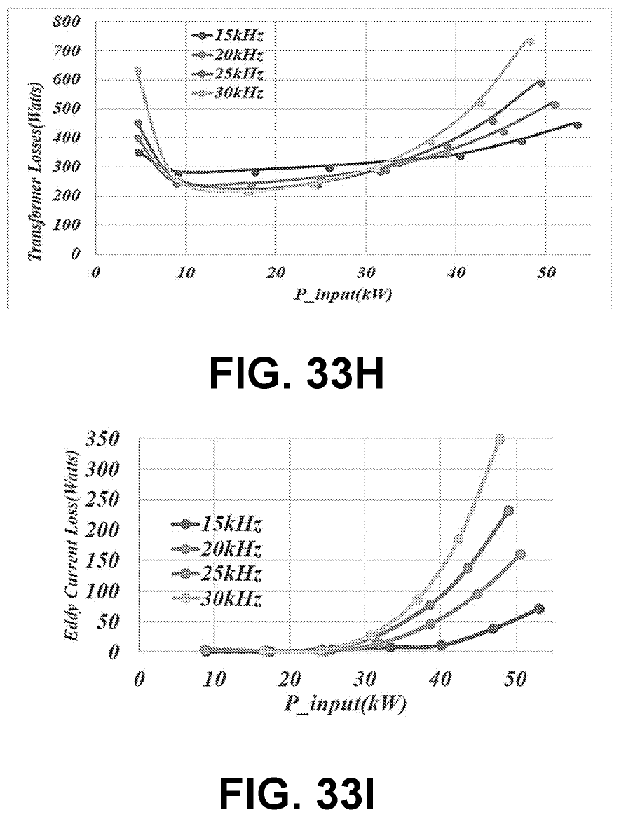

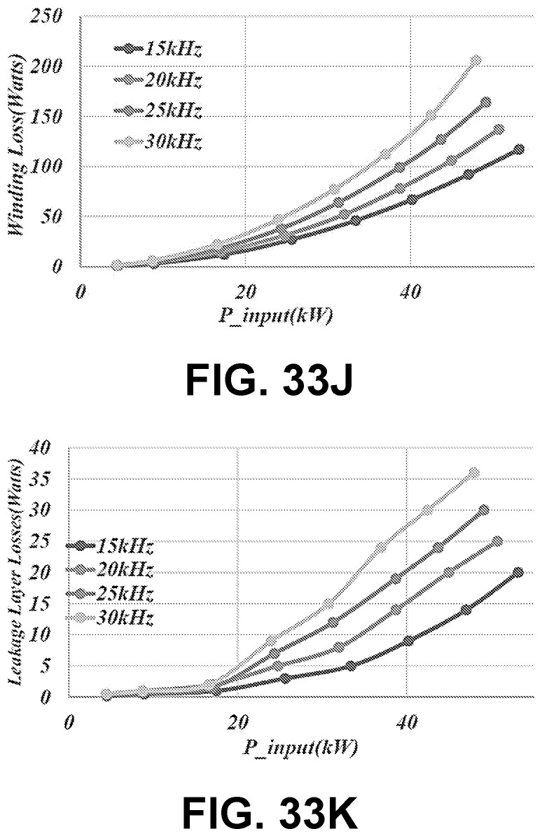

The two-port transformer with integrated nano-crystalline core and ferrite leakage layer positioned between the windings was tested using the prototype shown in FIG. 30B. The transformer is rated for 50 kW power with operating frequencies around 20 kHz. The transformer was operated at 15 kHz, 20 kHz, 25 kHz & 30 kHz switching frequencies and the experimental results are analyzed. FIG. 32 is a schematic diagram illustrating the test setup of the two-port DAB converter, where V_{dcl}=V_{dc2}=800V. FIGS. 33A and 33B show the transformer winding voltage & current waveforms at 15 kHz & 30 kHz switching frequencies with 50 kW power.

The converter efficiency and the input & output powers were measured using a WT3000 power analyzer. The efficiency and losses for the converter system are shown in FIGS. 33C and 33D, respectively. The transformer core losses are measured by applying the same quasi square wave voltage across both the windings over the full operating range. The total losses measured from power analyzer are shown in FIG. 33D.

The core loss for the nano-crystalline transformer for a particular operating point can be measured by applying the same quasi-square wave voltage for both V₁ and V₂ with no phase shift. FIG. 33E shows the magnetizing voltage and induced flux pattern. If L₁=L₂, then the induced voltage across the magnetizing inductances can be derived as

$${V}_{m} = \frac{{V}_{1} + {V}_{2}}{2} .$$

Thus for a particular operating point with phase angle ϕ, the magnetizing voltage Vₘ can be recreated by introducing a zero voltage in the H-bridge converter output voltage. The duration of zero voltage in H-bridge converter output voltage is ϕ in half cycle π. A waveform of similar induced voltage across a sense coil on the core of the transformer is shown in FIG. 33F.

The measured transformer core losses at different frequencies for the nano-crystalline transformer is shown in FIG. 33G. Considering Zero Voltage Switching (ZVS) for Dual Active Bridge converter, the switching losses can be considered zero for SiC Mosfet devices, as the turn-on is soft-switched and the actual turn-off loss is negligible. The conduction loss for SiC Mosfet devices are derived from PLECS simulation using conduction loss model and thermal model of device package resistance and heatsink resistance. There the total transformer loss and stray losses can be derived as:

P_{Transformer_total}=P_{Loss_total}−P_{MOSFET_conduction}

The total transformer loss variation is shown in FIG. 33H.

It can be observed that at very low power, the losses are higher and as loading increases, the losses go down initially and then increase with loading again. This may be attributed to very low loading, where the converter loses ZVS due to insufficient energy in leakage inductor and has sufficient switching losses, but as loading increases, the converter moves into ZVS operating region and switching losses become negligible. The losses in transformer winding and leakage layers can be estimated using conventional technique of estimating copper losses and inductor core losses (using an iGSI method). In the integrated transformer of FIG. 30B, there is a significant amount of eddy current loss over the transformer window volume portion, where some portion of leakage flux cuts through the laminations onto the windings. This may be attributed to the difference between total leakage of the transformer (50 μH) and leakage due to ferrite leakage layer (10 μH). The eddy current loss variation over transformer window, as illustrated in FIG. 33I over the input power, can be estimated as difference between total transformer loss and sum of core loss, copper loss and leakage layer loss,

P_{Eddy}=P_{Transformer_total}−P_{Transformer_hysteresis_core_loss}−P_{Transformer_copper_loss}−P_{Leakage_Layer}

In estimating the copper and leakage layer losses, the effect of temperature was not considered. The estimated winding losses and leakage layer losses are shown in FIGS. 33J and 33K, where:

$${P}_{CU} = {\sum }_{n = 1}^{9} {I}_{rms , n}^{2} {R}_{ac\_total , n}$$

$${P}_{L} = \frac{1}{T} {\int }_{0}^{T} {k}_{1} {\vert \frac{dB}{dT} \vert}^{α} {\vert B ( t ) \vert}^{β - α}$$

This disclosure has shown the importance of leakage and stray flux induced losses. These losses can be significantly higher than the typical loss models predict for magnetic components. A magnetic equivalent circuit model that segregates the different flux paths into lossy and lossless paths can be utilized in the design process. The permeances for these paths can be constructed from simple constituent geometries that relate to the magnetic component construction. Shielding the magnetic flux was provided whereby the flux is directed away from the wide surfaces of the magnetic ribbon and through a high resistivity ferrite core. Both a bar and wing geometry were examined with magnetic equivalent circuits and test circuits. The shields greatly reduced the measured leakage losses while having minimal impact on magnetizing losses. Using the wing shield geometry, the transformer leakage inductance can be tuned independently of the magnetizing core and general transformer geometry. The leakage shielding was integrated into a two-port transformer, which was tested to show that the shielding was effective at improving operation of the circuit.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that do not negatively impact the intended purpose or no longer becomes effective for the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

1. A magnetic core, comprising:
a ribbon core; and
leakage prevention or redirection shielding surrounding at least a portion of the ribbon core, the leakage prevention or redirection shielding positioned adjacent to the ribbon core and between the ribbon core and a magnetomotive force (MMF) source.

2. The magnetic core of claim 1, wherein the MMF source is a coil wound around a portion of the ribbon core.

3. The magnetic core of claim 2, wherein the leakage prevention or redirection shielding extends beyond ends of the coil.

4. The magnetic core of claim 1, wherein the leakage prevention or redirection shielding is a bar shield.

5. The magnetic core of claim 1, wherein the leakage prevention or redirection shielding is a wing shield.

6. The magnetic core of claim 5, wherein the wing shield comprises wings that extend over ends of the MMF source.

7. The magnetic core of claim 1, wherein the leakage prevention shielding comprises leakage prevention shielding material selected from Cu, Al, or mu metal.

8. The magnetic core of claim 1, wherein the leakage prevention or redirection shielding comprises leakage redirection shielding material selected from mu metal, lower permeability ribbon, powder core, or ferrite.

9. The magnetic core of claim 1, wherein the leakage prevention or redirection shielding comprises permeability engineered tape wound core material.

10. The magnetic core of claim 1, wherein the MMF source is offset from the leakage prevention or redirection shielding by a distance.

11. The magnetic core of claim 10, wherein the leakage prevention or redirection shielding extends over ends of the MMF source, the leakage prevention or redirection shielding offset from the ends of the MMF source by the distance.

12. The magnetic core of claim 1, wherein the leakage prevention or redirection shielding is positioned along a portion of an inner surface of the ribbon core and a portion of an outer surface of the ribbon core opposite the portion of the inner surface.

13. The magnetic core of claim 12, wherein the leakage prevention or redirection shielding positioned along the outer surface of the ribbon core extends beyond ends of the leakage prevention or redirection shielding positioned along the inner surface of the ribbon core.

14. A magnetic device, comprising:
a ribbon core;
leakage prevention or redirection shielding; and
a magnetomotive force (MMF) source positioned around at least a portion of the ribbon core, where at least a portion of the leakage prevention or redirection shielding is between the ribbon core and the MMF source.

15. The magnetic device of claim 14, wherein the magnetic device is a transformer.

16. The magnetic device of claim 14, wherein the MMF source is a coil wound around a portion of the ribbon core.

17. The magnetic device of claim 16, wherein the coil is wound around a second coil that is wound around the portion of the ribbon core, and the leakage prevention or redirection shielding is between the two coils.

18. The magnetic device of claim 14, wherein the leakage prevention or redirection shielding is a bar shield extending between ends of the MMF source.

19. The magnetic device of claim 14, wherein the leakage prevention or redirection shielding is a wing shield extending over ends of the MMF source.

20. The magnetic device of claim 14, wherein the MMF source is offset from the leakage prevention or redirection shielding by a distance.
